(19) United States
(12) Patent Application Publication
(10) Pub. No.: US 2026/0118687 A1
(43) Pub. Date: Apr. 30, 2026

(54) LASER ASSEMBLY WITH RADIALLY COMBINED BEAMS

(71) Applicant: Daylight Solutions, Inc., San Diego, CA (US)

(72) Inventors: Vladimir Andreevich Joshkin, Madison, WI (US); Michael Pushkarsky, San Diego, CA (US)

(21) Appl. No.: 19/479,999

(22) PCT Filed: May 1, 2024
(86) PCT No.: PCT/US2024/027163

§ 371 Date: Oct. 29, 2025

Related U.S. Application Data
(60) Provisional application No. 63/463,497, filed on May 2, 2023.

(51) Int. Cl. G02B 27/12; G02B 19/00; G02B 27/10

(52) U.S. Cl. CPC G02B 27/123; G02B 19/0009; G02B 19/0047; G02B 27/1006

(57) ABSTRACT

A laser assembly (12) of a system (10) includes a first emitter assembly (30a), a second emitter assembly (30b), and a combiner lens (34). The first emitter assembly (30a) generates a first emitter beam (22a) that is directed along a first emitter axis (32a) at a beam intersection area (31). The second emitter assembly (30b) generates a second emitter beam (22b) that is directed along a second emitter axis (32b) at the beam intersection area (31). The combiner lens (34) receives and spatially combines the first emitter beam (22a) and the second emitter beam (22b) after the emitter beams (22a) (22b) have intersected at and passed through the beam intersection area (31). The laser assembly (12) includes a laser frame (18); an emitter array (20) that generates a plurality of emitter beams (22); a combiner lens assembly (24) that transforms and combines the plurality of emitter beams (22) into the assembly output beam (14); and a system controller (26) that controls the operation of the laser assembly (12). The combiner lens assembly (24) including combiner lenses (34, 36, 38) has a fast axis, front side focal point (24a), and a fast axis and slow axis, rear side focal point (24b). It is positioned so that its fast axis front side focal point (24a) is approximately at the beam intersection area (31). The optical fiber (16) is positioned so that its inlet facet (16A) is approximately at the fast axis and slow axis, rear side focal point (24b).

### RELATED APPLICATION

This application claims priority on U.S. Provisional Application No. 63/463,497, filed on May 2, 2023, and entitled “LASER ASSEMBLY WITH RADIALLY COMBINED BEAMS”. As far as permitted, the contents of U.S. Provisional Application No. 63/463,497 are incorporated herein by reference.

### BACKGROUND

Laser assemblies can be used in many fields such as Lidar, medical diagnostics, pollution monitoring, leak detection, analytical instruments, homeland security, remote chemical sensing, industrial process control, and jamming of heat-seeking missiles.

One type of laser assembly includes (i) an array of side-by-side emitters positioned in a staircase arrangement that generates an array of beams; and (ii) an array of small, ninety degree, turn mirrors positioned in a staircase arrangement that directs the beams to form an array of co-propagating, vertically stacked, side-by-side beams.

Unfortunately, the step height of the staircase arrangement limits the maximum number of emitters that can be utilized for a given output beam. Moreover, the mirrors are sensitive to optomechanical misalignment and the small mirrors are hard to accurately hold in alignment when subjected to vibration loads and temperature fluctuations. Further, the optical surface of a small mirror is prone to degrade in the proximity of the mirror edge. Thus, larger mirrors are often used to improve reliability. However, larger mirrors require increased beam-to-beam spacing. Moreover, as the beam-to-beam spacing is increased, the number of emitters is decreased for the same form-factor, and the overall brightness of the output beam is reduced. Moreover, the repair and replacement of the mirrors is difficult.

Manufacturers are always searching for ways to reduce cost, reduce form factor, improve reliability, improve efficiency, improve beam quality, and improve power output of these laser assemblies.

### SUMMARY

A laser assembly that generates an assembly output beam can include a first emitter assembly, a second emitter assembly, and a first combiner lens. In this design, (i) the first emitter assembly generates a first emitter beam that is directed along a first emitter axis at a beam intersection area; (ii) the second emitter assembly generates a second emitter beam that is directed along a second emitter axis at the beam intersection area; (iii) the first combiner lens receives and spatially combines the first emitter beam and the second emitter beam after the first emitter beam and the second emitter beam have intersected at and passed through the beam intersection area.

In this design, the emitter beams can be spatially combined without any intermediary, individual turn mirrors for each emitter assembly. This minimizes the number of components in the laser assembly, and reduces the number of components that need to be accurately manufactured and maintained in alignment. Moreover, without the individual turn mirrors, there is more space to add additional emitter assemblies for a given form factor to increase the output power of the assembly output beam. Stated differently, with the present design, the laser assembly can be made less expensively, with a smaller form factor, and with improved quality of the assembly output beam. Moreover, with this design, the output of multiple emitters can be easily combined to increase the power output of the laser assembly.

In one implementation, the emitter assemblies are spaced apart and radially positioned relative to the beam intersection area. Further, the emitter axes can be radially positioned relative to the beam intersection area.

Each emitter assembly can have a fast axis, and the first combiner lens can be a fast axis collimating lens that causes the emitter beams to travel substantially parallel as a parallel beam set. Additionally, the laser assembly can include a second combiner lens that condenses the parallel beam set along a slow axis that is orthogonal to the fast axis and focuses the parallel beam set along the slow axis onto a rear side focal area. Moreover, the laser assembly can include a third combiner lens that condenses the parallel beam set along the fast axis to focus the assembly beam along the fast axis on the rear side focal area. With this design, an optical fiber having an inlet facet can be positioned approximately at the rear side focal area to fiber couple the assembly output beam. It should be noted that the acceptable range of “positioned approximately at the rear side focal area” will vary according to a number of factors, including the design of the optical fiber. As alternate, non-exclusive examples, the optical facet is positioned approximately at the rear side focal area if it is within 100, 120, 150 or 200 microns.

Additionally, the laser assembly can include a third emitter assembly that generates a third emitter beam that is directed along a third emitter axis at the beam intersection area. Moreover, the laser assembly can include a fourth emitter assembly that generates a fourth emitter beam that is directed along a fourth emitter axis at the beam intersection area. In this design, the emitter beams converge at the beam intersection area, and the emitter axes are radially positioned relative to the beam intersection area.

In one implementation, one or more of the emitter assemblies includes an emitter, a fast axis collimating lens that is spaced apart from the emitter, and a slow axis collimating lens that is spaced apart from the fast axis collimating lens and the emitter.

In one implementation, the first emitter beam has a first center wavenumber and the second emitter beam has a second center wavenumber that is approximately the same as the first center wavenumber. In a different implementation, the second center wavenumber is different from the first center wavenumber.

The first combiner lens can have a focal point, and the first combiner lens can be positioned so that the focal point is positioned at the beam intersection area.

In another implementation, the laser assembly includes: (i) a first emitter array that generates a plurality of first emitter beams that are directed to converge upon and intersect at a first beam intersection area; and (ii) a combiner lens assembly that receives and spatially combines the first emitter beams after the first emitter beams have passed through the first beam intersection area. In this design, each of the first emitter beams has a different angle of incidence relative to an imaginary plane positioned at the first beam intersection area.

Further, in this design, the first emitter beams can be radially positioned relative to the first beam intersection area.

Each first emitter beam can have a fast axis, and the combiner lens assembly can include a fast axis collimating lens that causes the emitter beams to travel substantially parallel as a parallel beam set. Moreover, the combiner lens assembly can include a slow axis condensing lens that condenses the parallel beam set along a slow axis that is orthogonal to the fast axis and focuses the parallel beam set along the slow axis onto a rear side focal area. Additionally, the combiner lens assembly can include a fast axis condensing lens that condenses the parallel beam set along the fast axis to focus the assembly beam along the fast axis on the rear side focal area. With this design, an optical fiber having an inlet facet can be positioned approximately at the rear side focal area to fiber couple the assembly output beam.

The combiner lens assembly has a fast axis, front focal point, and the combiner lens assembly can be positioned so that the fast axis, front focal point is positioned at the first beam intersection area.

Additionally, the laser assembly can include a second emitter array that generates a plurality of second emitter beams that are directed to converge upon and intersect at a second beam intersection area that is spaced apart from the first beam intersection area. In this design, each of the second emitter beams has a different angle of incidence relative to an imaginary plane positioned at the second beam intersection area. Further, the combiner lens assembly receives and spatially combines the second emitter beams after the second emitter beams have passed through the second beam intersection area.

In another implementation, the laser assembly comprises: (i) a first level emitter array that generates a plurality of first level emitter beams that are directed to converge upon and intersect at a first level beam intersection area; (ii) a second level emitter array that generates a plurality of second level emitter beams that are directed to converge upon and intersect at a second level beam intersection area; and a combiner lens assembly. In this design, the combiner lens assembly (i) receives and spatially combines the first emitter beams after the first emitter beams have passed through the first beam intersection area; and (ii) receives and spatially combines the second emitter beams after the second emitter beams have passed through the second beam intersection area. Moreover, the combiner lens assembly can subsequently spatially combine the first emitter beams and the second emitter beams.

In another implementation, a method for providing an assembly output includes: (i) directing a first emitter beam along a first emitter axis at a beam intersection area; (ii) directing a second emitter beam along a second emitter axis at the beam intersection area; wherein the first emitter beam and the second emitter beam intersect at the beam intersection area; and (iii) spatially combining the first emitter beam and the second emitter beam with a first combiner lens after the first emitter beam and the second emitter beam have passed through the beam intersection area.

In yet another implementation, a method for providing an assembly output beam includes: (i) directing a plurality of emitter beams to converge upon and intersect at a beam intersection area; wherein each of the emitter beams has a different angle of incidence relative to an imaginary plane positioned at the beam intersection area; and (ii) spatially combining the emitter beams after the emitter beams have passed through the beam intersection area with a combiner lens assembly.

In still another implementation, the invention is directed to laser assembly that generates an output beam. As provided herein, the laser assembly can include one or more of the following features: (i) a first emitter assembly that generates a first emitter beam that is directed along a first emitter axis at a first beam intersection area; (ii) a second emitter assembly that generates a second emitter beam that is directed along a second emitter axis at the first beam intersection area; wherein the first emitter beam and the second emitter beam intersect at the first beam intersection area; and/or (iv) a first combiner lens that receives and spatially combines the first emitter beam and the second emitter beam after the first emitter beam and the second emitter beam have passed through the first beam intersection area.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a simplified, perspective illustration of a system;

FIG. 1B is a simplified perspective illustration of an emitter assembly from the system of FIG. 1A;

FIG. 1C is a cut-away view taken on line 1C-1C of FIG. 1B;

FIG. 1D is a simplified, side view of the emitter assembly of FIG. 1B;

FIG. 1E is a simplified, top view of the emitter assembly of FIG. 1B;

FIG. 1F is a simplified, fast axis schematic of two emitter assemblies from FIG. 1A;

FIG. 1G is a simplified, slow axis schematic of one emitter assembly from FIG. 1A;

FIG. 1H is a simplified illustration of a plurality of emitter beams converging at a beam intersection area;

FIG. 2A is a simplified perspective illustration of a portion of another implementation of the system;

FIG. 2B is a top illustration of the system of FIG. 2A;

FIG. 2C is a side illustration of the system of FIG. 2A;

FIG. 2D is an end illustration of the system of FIG. 2A;

FIG. 2E is a simplified illustration of the profile of the combined first level emitter beams;

FIG. 2F is a simplified illustration of the profile of the combined first level emitter beams and second level emitter beams, and the profile of the combined third level emitter beams and fourth level emitter beams;

FIG. 2G illustrates the profile of the assembly output beam at the inlet facet of the optical fiber 16;

FIG. 3A is a simplified perspective illustration of a portion of yet another implementation of the system;

FIG. 3B is a top illustration of the system of FIG. 3A;

FIG. 3C is a side illustration of the system of FIG. 3A;

FIG. 4A is a simplified perspective illustration of a portion of still another implementation of the system;

FIG. 4B is an enlarged view from FIG. 4A;

FIG. 5A is a simplified perspective illustration of a portion of another implementation of the system;

FIG. 5B is a top illustration of the system of FIG. 5A;

FIG. 5C is a side illustration of the system of FIG. 5A;

FIG. 5D is a first perspective view of an emitter assembly from FIG. 5A; and

FIG. 5E is an alternative perspective view of the emitter assembly from FIG. 5A.

### DESCRIPTION

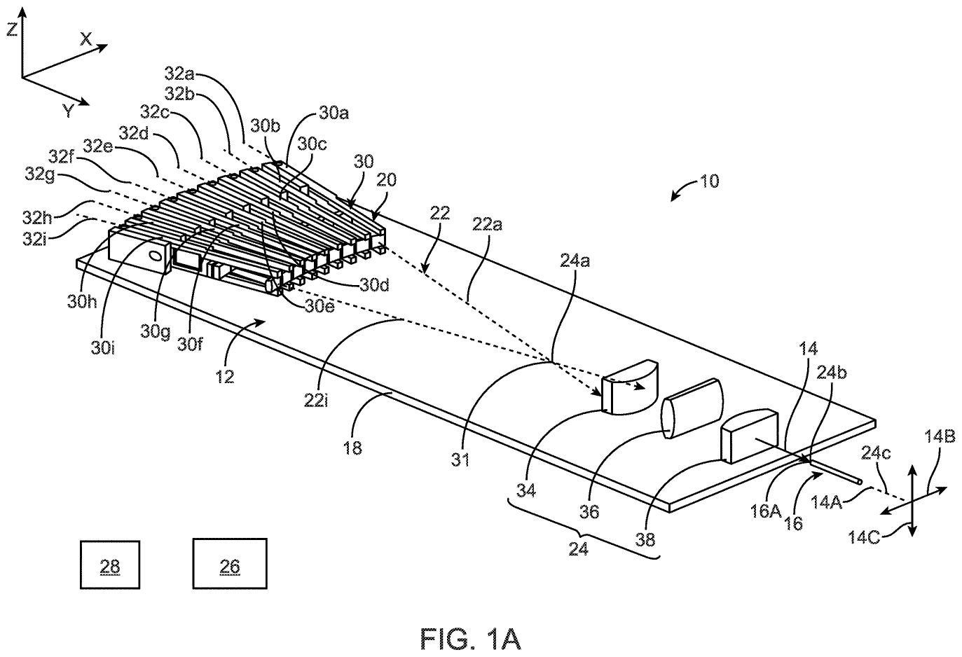

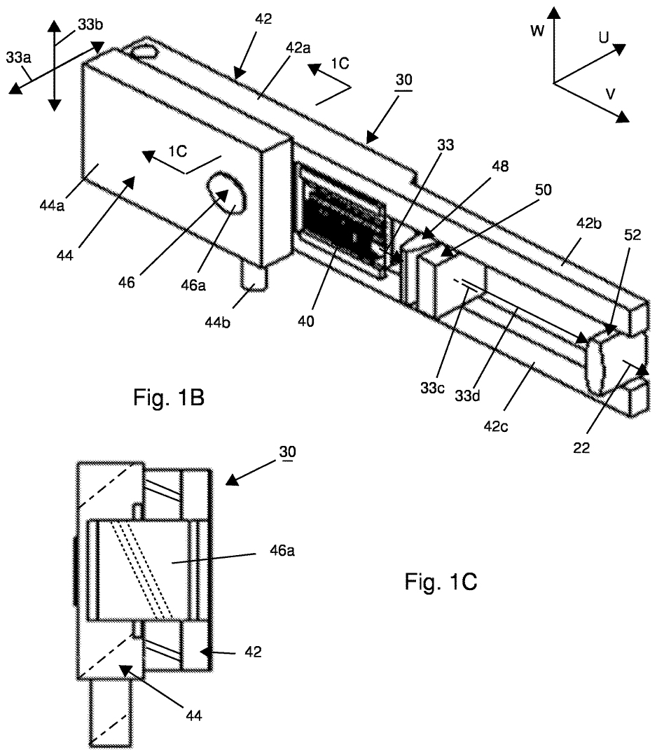

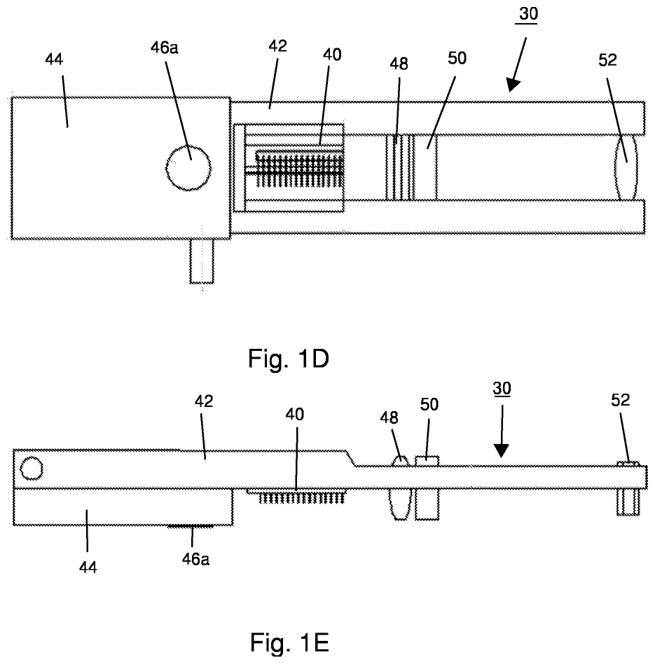

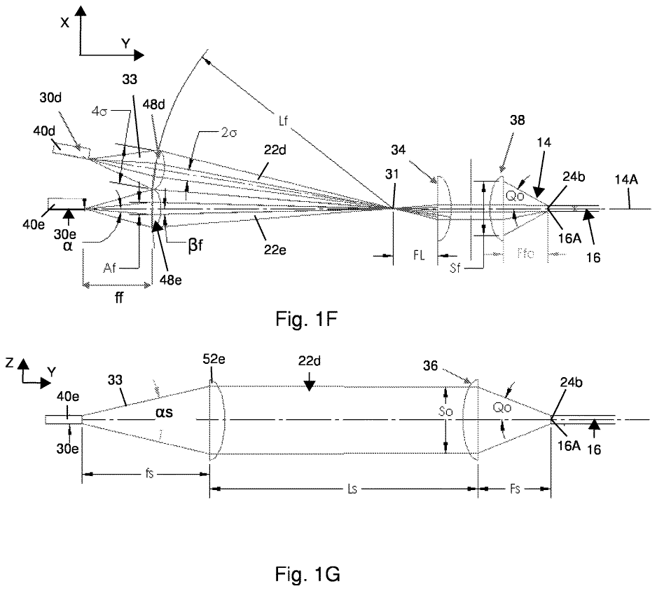

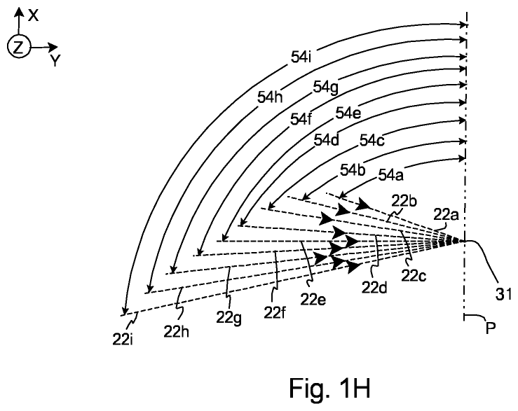

FIG. 1A is a top, perspective illustration of a first implementation of a system 10 that includes a laser assembly 12 that generates an assembly output beam 14 (illustrated with an arrow) directed along an output axis 14A, and an optical fiber 16 having an inlet facet 16A. In this non-exclusive implementation, the assembly output beam 14 is directed at the inlet facet 16A which is substantially coaxial with the output axis 14A. In this design, the assembly output beam 14 enters the optical fiber 16, and is fiber coupled. Alternatively, the laser assembly 12 could be designed to launch the assembly output beam 14 into open space.

In certain implementations, the laser assembly 12 includes (i) a laser frame 18; (ii) an emitter array 20 that generates a plurality of emitter beams 22 (two are illustrated as dashed lines in FIG. 1A); (iii) a combiner lens assembly 24 that transforms and combines the plurality of emitter beams 22 into the assembly output beam 14; and (v) a system controller 26 (illustrated as a box) that controls the operation of the laser assembly 12. The design of each of the components of the laser assembly 12 can be varied to adjust the characteristics of the assembly output beam 14.

It should be noted that a power supply 28 (e.g., a battery, the electrical grid, or a generator) can provide electrical power to the system controller 26 to selectively power the emitter array 20.

Further, the laser assembly 12 can be secured to a mount (not shown) such as a test or experimental bench, a frame of a vehicle or aircraft, or other rigid structure. Moreover, the mount can be thermally isolated and/or can have active thermal control. For example, the mount may include a thermal controller (not shown) that controls the temperature of the laser frame 18, and/or the emitter array 20. For example, the thermal controller can include (i) one or more pumps (not shown), chillers (not shown), heaters (not shown), and/or reservoirs that cooperate to circulate a hot or cold circulation fluid (not shown) through the laser frame 18 to control the temperature of the laser frame 18 and the emitter array 20.

In certain embodiments, the emitter array 20 includes a plurality of individual emitter assemblies 30 that are designed and positioned so that the plurality of emitter beams 22 radially converge upon, spatially overlap and intersect at a beam intersection area 31. Further, the combiner lens assembly 24 receives and collects the emitter beams 22 after passing through the beam intersection area 31, and spatially combines these emitter beams 22 to provide the assembly output beam 14 which can be coupled to the optical fiber 16. In this design, the plurality of emitter beams 22 converge upon the beam intersection area 31, and are spatially combined without any intermediary, individual turn mirrors (not shown) for each emitter assembly 30. This minimizes the number of components in the laser assembly 12 and reduces the number of components that need to be accurately manufactured and maintained in alignment. As provided herein, turn mirrors are sensitive to optomechanical misalignment, which can reduce the performance of the laser assembly.

Moreover, without the turn mirrors (or other structures), the beam-to-beam spacing can be reduced, thereby allowing for a higher density (larger number) of emitter assemblies 30 for a given form-factor, and a higher power, assembly output beam 12. Stated differently, the present design allows for getting more power out of the laser assembly 12 with a relatively small footprint. Further, without turn mirrors, the laser assembly 12 is more stable and reliable because the mirrors are subject to degradation at the edges. Moreover, without the turn mirrors, the emitter beams 22 are easier to align.

As a result of the present design, the laser assembly 12 can be made less expensively, with a smaller form-factor, and improved stability and power of the assembly output beam 14. Further, with this design, multiple emitter beams 22 can be easily combined to increase the power output of the laser assembly 12.

FIG. 1A includes a system orientation system that illustrates an X axis, a Y axis that is orthogonal to the X axis and a Z axis that is orthogonal to the X and Y axes. In FIG. 1A, for the system orientation system, the Y axis is parallel to the output axis 14A of the assembly output beam 14. It should be noted that these axes can also be referred to as the first, second and third axes.

The laser frame 18 is rigid, thermally stable, supports the other components of the laser assembly 12, and maintains the precise alignment of the components of the laser assembly 12. In FIG. 1A, for simplicity, the laser frame 18 is illustrated as a flat plate. However, for example, the laser frame 18 can be a sealed or unsealed housing that encircles and provides a controlled environment for the other components of the laser assembly 12. If the laser frame 18 is a housing, the laser frame 18 can include a window (not shown) for the assembly output beam 14 to exit the laser frame 18, or inlet facet 16A can be positioned in the housing. Further, if the laser frame 18 is sealed, it can be filled with an inert gas, or another type of fluid, or the sealed chamber can be subjected to a vacuum. Still alternatively, for example, desiccant or another drying agent can be positioned in the laser frame 18 to trap gases that could absorb laser emissions, cause corrosion, and/or to cause condensation.

The emitter array 20 generates the plurality of emitter beams 22 that are radially directed at the beam intersection area 31, and spatially combined into the assembly output beam 14. The number, positioning, size, shape and design of the emitter assemblies 30 can be varied to achieve the desired characteristics of the assembly output beam 14.

In one implementation, the plurality of spaced apart emitter assemblies 30 are organized in a radial pattern relative to the beam intersection area 31, with each emitter assembly 30 generating a separate emitter beam 22 that is radially directed at the beam intersection area 31. In the non-exclusive implementation of FIG. 1A, the emitter array 20 includes nine emitter assemblies 30. In this design, for ease of discussion, the emitter assemblies 30 can be labeled (i) a first emitter assembly 30a that emits and directs a first emitter beam 22a at the beam intersection area 31 along a first emitter axis 32a; (ii) a second emitter assembly 30b that emits and directs a second emitter beam (not shown in FIG. 1A) at the beam intersection area 31 along a second emitter axis 32b; (iii) a third emitter assembly 30c that emits and directs a third emitter beam (not shown in FIG. 1A) at the beam intersection area 31 along a third emitter axis 32c; (iv) a fourth emitter assembly 30d that emits and directs a fourth emitter beam (not shown in FIG. 1A) at the beam intersection area 31 along a fourth emitter axis 32d; (v) a fifth emitter assembly 30e that emits and directs a fifth emitter beam (not shown in FIG. 1A) at the beam intersection area 31 along a fifth emitter axis 32e; (vi) a sixth emitter assembly 30f that emits and directs a sixth emitter beam (not shown in FIG. 1A) at the beam intersection area 31 along a sixth emitter axis 32f; (vii) a seventh emitter assembly 30g that emits and directs a seventh emitter beam (not shown in FIG. 1A) at the beam intersection area 31 along a seventh emitter axis 32g; (viii) an eighth emitter assembly 30h that emits and directs an eighth emitter beam (not shown in FIG. 1A) at the beam intersection area 31 along an eighth emitter axis 32h; and (ix) a ninth emitter assembly 30i that emits and directs a ninth emitter beam 22i at the beam intersection area 31 along a ninth emitter axis 32i. Alternatively, the emitter array 20 can be designed to have more than or fewer than nine emitter assemblies 30. As non-exclusive examples, the laser assembly 12 can be designed to have at least two, five, ten, fifteen, eighteen, twenty, thirty, forty, fifty, seventy-two, or more emitter assemblies 30.

It should be noted that any of the emitter assemblies 30 can be referred to as the first, second, third, etc., emitter assembly 30. Somewhat similarly, any of the emitter beams 22 can be referred to as a first, second, third, etc. emitter beam 22, or as a first, second, third, etc. laser beam.

As provided herein, the emitter array 20 has an emitter pitch, which represents the number and spacing of emitter assemblies 30. Stated differently, the emitter assemblies 30 are arranged to have an emitter spacing (also referred to as an “emitter separation angle”) between adjacent emitters assemblies 30. In FIG. 1A, the emitter assemblies 30 are spaced apart radially. Further, the emitter spacing can be varied based on the design of the other components of the laser assembly 12. For example, the factors that influence acceptable emitter pitch can include, (i) the desired number of emitter assemblies 30, (ii) the fast axis divergence angle of each emitter assembly 30, (iii) the numerical aperture and size of the inlet facet 16A of the optical fiber 16, and/or (iv) the ability to sufficiently remove the heat from the emitter assemblies 30. As alternative, non-exclusive examples, the emitter spacing can be less than or equal to approximately 0.5, 1, 1.2, 1.3, 1.4, 1.5, 2, 2.5, 3, 3.1, 3.2, 3.5, 5, 10 or larger degrees. Stated in another fashion, the emitter spacing can be between approximately 0.5 and 10 degrees. However, other emitter spacings are possible.

In one non-exclusive implementation, the emitter array 20 is designed so that the emitter assemblies 30 are equally spaced, and the emitter array 20 is uniform. In this design, the emitter array 20 can be referred to as having a uniform spacing or uniform emitter pitch. Alternatively, the emitter spacing can be a non-uniform distribution.

Additionally, in alternative, non-exclusive embodiments, each emitter assembly 30 can be designed and powered so that its emitter beam 22 has a power of at least approximately 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or 30 Watts. However, other output powers are possible, such as less than 0.5 watts or greater than 30 watts.

With the present design, the optical power of the assembly output beam 14 can be changed by changing the number of emitters assemblies 30 used in the emitter array 20. Thus, the design of laser assembly 12 can be easily adjusted to add or remove emitter assemblies 30 based on the desired output power of the assembly output beam 14. As a non-exclusive example, the laser assembly 12 can be designed so that the assembly output beam 14 has an optical power of between five to one hundred watts. Stated in another fashion, in alternative, non-exclusive embodiments, the laser assembly 12 can be designed so that the assembly output beam 14 has an optical power of at least five, ten, fifteen, twenty, twenty-five, thirty, thirty-five, forty, forty-five, fifty, sixty, eighty, or one hundred watts. However, optical powers of less than five, or greater than one hundred watts are possible.

With the present design, the laser assembly 12 is a compact, high efficiency, high output, laser assembly 12 that spatially combines the emitter beams 22 of multiple individual emitter assemblies 30 into the assembly output beam 14. As a result, multiple emitter assemblies 30, each generate a separate emitter beam 22 having relatively moderate output power, that is combined into a multi-Watt module configuration that offers many practical benefits. For example, a lower per-facet intensity of each emitter assembly 30 translates into lower thermal stress on the individual emitter assembly 30, providing more long-term system reliability. In addition, emitter assemblies 30 with lower power requirements can be manufactured with much higher yields, providing a dependable supply at lower costs.

The design of each emitter assembly 30 can be varied to adjust the characteristics of the assembly output beam 14. A non-exclusive implementation of one of the first emitter assemblies 30 is described in more detail in reference to FIG. 1B below. As illustrated in FIG. 1B, each emitter assembly 30 can generate a diverging, elliptical initial beam 33 (illustrated with an arrow) having an oval shaped cross-section. In this non-exclusive example, the initial beam 33 has a first diverging rate along a first axis 33a (illustrated with two headed arrow), and a second diverging rate along a second axis 33b (illustrated with two headed arrow) that is orthogonal to the first axis 33a. In one example, the first diverging rate is greater than the second diverging rate. Stated in another fashion, the initial beam 33 is diverging faster along the first axis 33a, and is diverging slower along the second axis 33b. Thus, in this example, the first axis 33a can be referred to as the fast axis, and the second axis 33b can be referred to as the slow axis.

Referring back to FIG. 1A, a fast axis 14B for the combined emitter beams 22 (assembly output beam 14) is illustrated with a two headed arrow, and a slow axis 14C for the combined emitter beams 22 (assembly output beam 14) is also illustrated with a two headed arrow. In FIG. 1A, the fast axis 14B is parallel to the X axis of the system orientation system, and the slow axis 14C is parallel to the Z axis of the system orientation system.

As provided above, in one implementation, the emitter assemblies 30 are organized in a radial pattern relative to the beam intersection area 31, with each emitter assembly 30 generating the separate emitter beam 22 along the separate emitter axis 32a-32i. With this design, each emitter axis 32a-32i is radially positioned relative to the beam intersection area 31, and each emitter beam 22 travels on a path that is radial to the beam intersection area 31. As a result, the emitter beams 22 converge upon, intersect, and spatially overlap at the beam intersection area 31 in front of the combiner lens assembly 24. In the non-exclusive implementation of FIG. 1A, the nine emitter beams 22 are directed to converge on the beam intersection area 31. In certain designs, after exiting the beam intersection area 31, the emitter beams 22 are diverging.

As provided herein, the resulting assembly output beam 14 is made up of the plurality of the individual emitter beams 22 that are directed and combined by the combiner lens assembly 24. In certain designs, each emitter assembly 30 is designed and controlled so that each emitter beam 22 is at approximately the same center wavenumber. In this design, the first emitter beam 22a has a first center wavenumber that is the same as a second center wavenumber for the second emitter beam, and a third center wavenumber of the third emitter beam.

In another design, each emitter assembly 30 is designed and controlled so that each emitter beam 22 is at approximately the same spectral range.

In a different design, one or more of the emitter assemblies 30 can be designed and controlled so that its emitter beam 22 has a different center wavenumber. In this design, the first center wavenumber of the first emitter beam 22a is the different from the second center wavenumber for the second emitter beam, and the third center wavenumber of the third emitter beam.

In yet another design, one or more of the emitter assemblies 30 can be designed and controlled so that its emitter beam 22 is in a different spectral range. In still another design, one or more of the emitter assemblies 30 can be designed to be selectively tunable.

The design of the combiner lens assembly 24 can be varied. In the implementation of FIG. 1A, (i) the combiner lens assembly 24 has a fast axis, front side focal point 24a, and a fast axis and slow axis, rear side focal point 24b; (ii) the combiner lens assembly 24 is positioned so that its fast axis front side focal point 24a is approximately at the beam intersection area 31; and (iii) the optical fiber 16 is positioned so that its inlet facet 16A is approximately at the fast axis and slow axis, rear side focal point 24b. Further, the combiner lens assembly 24 includes one or more elements (e.g., lenses) that cooperate to (i) receive the plurality of emitter beams 22 after they have converged on the beam intersection area 31 in front of the combiner lens assembly 24; (ii) direct the emitter beams 22 to be substantially parallel to one another (i.e., the emitter beams 22 travel along substantially parallel axes, and can be fully or partly spatially overlapping); and (iii) direct the emitter beams 22 to be focused and converge at the fast axis and slow axis, rear side focal point 24b. Alternatively, for example, the combiner lens assembly 24 can be designed so that the emitter beams 22 remain substantially parallel to one another as they exit the combiner lens assembly 24.

In the non-exclusive of FIG. 1A, the combiner lens assembly 24 includes a first combiner lens 34, a second combiner lens 36, and a third combiner lens 38 that are spaced apart along a lens axis 24c. Further, in the simplified example of FIG. 1A, the lens axis 24c is coaxial with the output axis 14A of the assembly output beam 14. Alternatively, the combiner lens assembly 24 can be designed to include fewer of more than three elements as described in more detail below in reference to subsequent embodiments.

In one design, the first combiner lens 34 (i) is a fast axis collimator lens having a fast axis front focal length that defines the fast axis front side focal point 24a of the combiner lens assembly 24; (ii) receives the plurality of emitter beams 22 after they have converged and passed through the beam intersection area 31; and (ii) directs the emitter beams 22 to be substantially parallel to one another (i.e., the emitter beams 22 travel along substantially parallel axes (e.g., along the Y axis), and can be fully or partly spatially overlapping). It should be noted that because of the design of each emitter assembly 30a-30i (described in more detail below with regards to FIG. 1B), each emitter beam 22a, 22i leaving its respective emitter assembly 30a-30i will be converging along the fast axis 33a, collimated along the slow axis 33b, and directed at the beam intersection area 31. As a result, each emitter beam 22a, 22i will have a line shaped configuration at the beam intersection area 31.

As a non-exclusive example, the fast axis collimator lens 34 can be a cylindrical lens that only acts on the fast axis of the emitter beams 22. In one, non-exclusive implementation, the first combiner lens 34 can be a cylindrical, plano-convex lens having a front focal length of approximately fifteen millimeters, a central thickness of approximately 3.8 millimeters, and a radius of approximately 7.8 millimeters. However, other designs of the first combiner lens 34 are possible.

Further, in one design, the second combiner lens 36 is a slow axis condenser lens that directs the emitter beams 22 to converge and focus on a slow axis, rear side focal point of the second combiner lens 36. In this design, the second combiner lens 36 is designed and positioned so that its slow axis, rear side focal point is at the location of the fast axis and slow axis, rear side focal point 24b. Stated in another fashion, the second combiner lens 36 defines the slow axis portion of the rear side focal point 24b.

For example, the slow axis collimator lens 36 can be a cylindrical lens that only acts on the slow axis of the emitter beams 22. As a non-exclusive example, the second combiner lens 36 can include a cylindrical, plano-convex lens having a focal length of approximately 22.19 millimeters, a central thickness of approximately 3.9 millimeters, and a radius of approximately 11.5 millimeters. However, other designs of the second combiner lens 36 are possible.

Moreover, in one design, the third combiner lens 38 is a fast axis condenser lens that directs the emitter beams 22 to converge and focus on a fast axis, rear side focal point of the third combiner lens 38. In this design, the third combiner lens 38 is designed and positioned so that its fast axis, rear side focal point is at the location of the fast axis and slow axis, rear side focal point 24b. Stated in another fashion, the third combiner lens 38 defines the fast axis portion of the rear side focal point 24b.

For example, the fast axis condenser lens 38 can be a cylindrical lens that only acts on the fast axis of the emitter beams 22. As non-exclusive example, the third combiner lens 38 can include a cylindrical, plano-convex lens having a focal length of approximately 15 millimeters, a central thickness of 3.8 millimeters, and a radius of approximately 7.8 millimeters. However, other designs of the third combiner lens 38 are possible.

In the design illustrated in FIG. 1A, (i) the front side focal length of the first combiner lens 34 defines the fast axis front side focal point 24a of the combiner lens assembly 24; (ii) the second combiner lens 36 is designed and positioned so that its slow axis, rear side focal point is at the location of the desired fast axis and slow axis, rear side focal point 24b; and (iii) the third combiner lens 38 is designed and positioned so that its fast axis, rear side focal point is at the location of the desired fast axis and slow axis, rear side focal point 24b. It should be noted that manufacturing and/or assembly tolerances may cause the second combiner lens 36 and/or the third combiner lens 38 to be slightly misplaced. As a result thereof, the desired fast axis and slow axis, rear side focal point 24b can be referred to as a rear side focal area.

The combiner lens 34, 36, 38 can be made of any material that is operable for the wavenumbers of the emitter beams 22.

It should be noted that other designs of the combiner lens assembly 24 are possible. For example, the second combiner lens 36 and the third combiner lens 38 can be replaced by a separate, spherical lens that performs both functions.

The system controller 26 controls the operation of the components of the laser assembly 12. For example, the system controller 26 can include one or more processors (not shown), and one or more electronic storage devices (not shown). In certain embodiments, the system controller 26 can control the electron injection current to the individual emitter assemblies 30. The system controller 26 can be a centralized or distributed system.

In certain designs, the system controller 26 is electrically connected to each of the emitter assemblies 30 and the power supply 28. For example, the system controller 26 can be electrically connected in series to the emitter assemblies 30. Alternatively, the system controller 26 can be electrically connected in parallel to the emitter assemblies 30 for individual control of the emitter assemblies 30. It should be noted that the wiring has been omitted from FIG. 1A to simplify this Figure.

The system controller 26 can individually or concurrently direct current to each of the emitter assemblies 30. For example, the system controller 26 can continuously direct power to one or more of the emitter assemblies 30. Alternatively, for example, the system controller 26 can direct power in a pulsed fashion to one or more of the emitter assemblies 30. In one embodiment, the duty cycle is approximately fifty percent. Alternatively, the duty cycle can be greater than or less than fifty percent.

It should be noted that in the pulsed mode of operation, the system controller 26 can simultaneous direct pulses of power to each of the emitter assemblies 30 so that each of the emitter assemblies 30 generates the respective emitter beams 22 at the same time. Alternatively, the system controller 26 can direct pulses of power to one or more of the emitter assemblies 30 at different times so that the emitter assemblies 30 generate the respective emitter beam 22 at different times.

As provided above, the design of each emitter assembly 30 can be varied. It should be noted that each of emitter assemblies 30 can have a similar design, or one or more of the emitter assemblies 30 can be different in design. FIG. 1B is a simplified perspective view of one of the emitter assemblies 30. In this implementation, the emitter assembly 30 includes the emitter 40, an emitter carrier 42, an emitter mount 44, a connector assembly 46, an emitter fast axis lens 48, an emitter beam shifter 50, and an emitter slow axis lens 52. The design and positioning of these components can be varied to achieve the design requirements of the laser assembly 12.

FIG. 1B includes an emitter orientation system that is referenced to the emitter assembly 30, and includes a U axis, a V axis that is orthogonal to the U axis and a W axis that is orthogonal to the U and V axes. For the emitter orientation system, the U axis is parallel to the emitter fast axis 33a, and the W axis is parallel to the emitter slow axis 33b. It should be noted that these axes can also be referred to as the first, second and third axes.

The emitter 40 generates the initial beam 33 along a beam central axis 33c when sufficient power is directed to the emitter 40. For example, the emitter 40 can be a semiconductor laser diode, such as a Gallium Antimony or Gallium Arsenide laser diode, or another type of laser diodes operating in CW, QCW or pulsed modes. Alternatively, for example, the emitter 40 can be a Quantum Cascade (“QC”) gain medium, or an interband cascade laser. Further, in one, non-exclusive embodiment, the emitter 40 is an infrared laser source that directly generates the initial beam 33 having a center wavelength that is in the mid to far infrared wavelength range of three to thirty microns. In another non-exclusive embodiment, the emitter 40 is a mid-infrared laser source that directly generates the initial beam 33 having a center wavelength that is in the mid-infrared wavelength range of two to twenty microns. However, the emitter 40 can be designed to generate the initial beam 33 having a center wavelength in other ranges than described above.

In one embodiment, each emitter 40 has a back facet and an opposed front facet that faces the emitter fast axis lens 48, and each emitter 40 is designed to only emit from the front facet. In this embodiment, the back facet is coated with a high reflectivity dielectric or metal/dielectric coating to minimize optical losses from the back facet. Further, the front facet can include a partly reflective dielectric coating.

Further, each emitter 40 can include one or more pads for electrical connection to the system controller 26.

The emitter carrier 42 retains the emitter 40, the emitter fast axis lens 48, the emitter beam shifter 50, and the emitter slow axis collimating lens 52 in a spaced apart configuration along the beam central axis 33c. In the non-exclusive implementation of FIG. 1B, the emitter carrier 42 is rigid, and includes (i) a generally rectangular shaped carrier body 42a; (ii) a generally rectangular shaped, first carrier arm 42b that cantilevers away from the carrier body 42a; and (iii) a generally rectangular shaped, second carrier arm 42c that cantilevers away from the carrier body 42a and that is spaced apart from the first carrier arm 42b. In this design, (i) the emitter 40 is attached to the carrier body 42a; and (ii) the emitter fast axis lens 48, the beam shifter 50, and the emitter slow axis lens 52 are attached in a spaced apart configuration to the carrier arms 42b, 42c.

In one embodiment, the emitter carrier 42 is made of rigid material that has a relatively high thermal conductivity to act as a conductive heat spreader. In certain embodiments, the material used for the emitter carrier 42 can be selected so that its coefficient of thermal expansion matches the coefficient of thermal expansion of the emitter 40. In one non-exclusive embodiment, the emitter carrier 42 has a thermal conductivity of at least approximately 170 watts/meter K. With this design, in addition to rigidly supporting the emitter 40, the emitter carrier 42 also readily transfers heat away from the emitter 40 to the emitter mount 44. For example, the emitter carrier 42 can be fabricated from a single, integral piece of copper, copper-tungsten (CuW), copper-moly, copper-molybdenum Carbide, aluminum-nitride (AIN), beryllium oxide (BeO), diamond, silicon carbide (SIC), or other material having a sufficiently high thermal conductivity. In another non-exclusive example, the emitter carrier 42 can comprise high thermal conductive materials as copper, copper-tungsten (CuW), copper-moly, copper-molybdenum Carbide, aluminum-nitride (AIN), beryllium oxide (BeO), diamond, silicon carbide (SiC), or other material having a sufficiently high thermal conductivity that carries the emitter and provide effective heat sink for the laser chip; and materials with low coefficient of the thermal expansion (CTE), as kovar, quartz or other materials having a sufficiently low CTE, for a cantilever/fork that carries the optical lenses.

It should be noted that the relatively thin carrier arms 42b, 42c minimize the amount of heat that is transferred to fast axis collimating lens 48, the emitter beam shifter 50, and the slow axis collimating lens 52.

The emitter mount 44 secures the emitter carrier 42 to the laser frame 18 (illustrated in FIG. 1A). In the non-exclusive implementation of FIG. 1B, the emitter mount 44 is rigid, and includes (i) a generally rectangular shaped mount body 44a; and (ii) a cylindrical shaped, mount rod 44b that cantilevers downward from the mount body 44a. Alternatively, the mount rod 44b can be a portion of a cylinder. With this non-exclusive design, the mount rod 44b can be positioned within a corresponding frame aperture (not shown) in the laser frame 18. Further, with this design, the emitter assembly 30 can be pivoted (rotated) about the W axis (about the slow axis 33b) relative to the laser frame 18 to adjust the pointing of the emitter beam 22 until it precisely converges upon and is directed at the beam intersection area 31 (illustrated in FIG. 1A). After the emitter beam 22 is properly pointed, the mount rod 44b can be fixedly secured to the laser frame 18, e.g., using an adhesive, solder, or another type of fastener (e.g., a set screw).

The emitter mount 44 can be made to have similar characteristics as the emitter carrier 42. In certain embodiments, the material used for the emitter mount 44 can be selected so that its coefficient of thermal expansion matches the coefficient of thermal expansion of the emitter 40 and the emitter carrier 42.

In certain designs, the emitter mount 44 and/or the emitter carrier 42 are thermally coupled to the laser frame 18 so that heat easily transfers from the emitter 40 to the emitter mount 44 and the emitter carrier 42, and subsequently to the laser frame 18.

The connector assembly 46 connects the carrier body 42 to the emitter mount 44 while allowing for adjustment of the position of the carrier body 42 and the emitter 40 relative to the emitter mount 44. In one non-exclusive implementation, the connector assembly 46 includes a cylindrical shaped pin 46a that is positioned in the carrier body 42 and the emitter mount 44. Alternatively, the pin 46a can be a portion of a cylinder. With this design, the carrier body 42 and the emitter 40 can be pivoted (rotated) about the U axis (about the fast axis 33a) relative to the emitter mount 44 and the laser frame 18 to adjust the pointing of the emitter beam 22 until it precisely converges upon and is directed at the beam intersection area 31. After the emitter beam 22 is properly pointed, the connector pin 46a can be fixedly secured to the emitter mount and the emitter carrier 42, using an adhesive or another type of fastener (e.g., a set screw).

With the present design, the mount rod 44b and the connector pin 46a allow for the easy alignment of the emitter beam 22 about two axes of rotation. Stated in a different fashion, with this design, each emitter assembly 30 can be accurately aligned and directly aligned without aligning any corresponding mirrors. Further, the emitter 40 mounted on the emitter carrier 42 positions the emitter 40 in the correct position so that the fast axis 33a and the slow axis 33b are properly aligned.

Stated differently, in FIG. 1B, the emitter 40 is directly mounted to the emitter carrier 42, which allows for alignment of the emitter beam 22 about two axis of rotation and place the fast axis 33a in the plane of the combiner lens assembly 24 (illustrated in FIG. 1A).

Moreover, with the present design, one or more of the emitter assemblies 30 can be easily removed and replaced in the laser assembly 12 (illustrated in FIG. 1A) without disassembling and disturbing the alignment of the other components in the laser assembly 12.

The emitter fast axis lens 48 is spaced apart from the emitter 40, receives the initial beam 33, and converges and focuses the initial beam 33 along the fast axis 33a. As a result thereof, the emitter beam 22 is converging along the fast axis 33a at the beam intersection area 31 after the emitter fast axis lens 48. In one example, the emitter fast axis lens 48 is designed and positioned so that the emitter beam 22 is focused on a common point at the beam intersection area 31. In this design, the emitter fast axis lens 48 is not a true collimating lens. For example, the emitter fast axis lens 48 can be a micro, cylindrical lens that does not act on the slow axis 33b component of the initial beam 33. Alternatively, for example, the emitter fast axis lens 48 can be designed to direct a collimated emitter beam 22 at the beam intersection area 31. As a non-exclusive example, the emitter fast axis lens can be a cylindrical plano-convex lens with focal length of approximately 1.45 mm.

The emitter beam shifter 50 is spaced apart from the emitter fast axis lens 48 and slightly shifts the initial beam 33. In certain designs, the emitter beam shifter can simplify the optical alignment procedure. Alternatively, the emitter assembly 30 could be designed without the emitter beam shifter 40. An adjusted, initial beam 33 that exits the emitter beam shifter 50 is represented with an arrow 33d. In the non-exclusive implementation of FIG. 1B, the beam central axis 33c of the initial beam 33 is slightly shifted from the corresponding emitter axis 32a-32i (illustrated in FIG. 1A) of the emitter assembly 30, because of the emitter beam shifter 50.

The emitter slow axis lens 52 is spaced apart from the emitter beam shifter 50 and can be a collimating lens that collimates the adjusted, initial beam 33 along the slow axis. As a result, the emitter beam 22 has an oval cross-sectional shape exiting the emitter slow axis lens 52, with the emitter beam 22 converging along the fast axis 33a (because of the emitter fast axis lens 48) and collimated along the slow axis 33b (because of the emitter slow axis lens 52). In this design, the emitter slow axis lens 52 can be a micro, collimating lens. For example, the emitter slow axis lens 52 can be a cylindrical lens that does not act on the fast axis 33a component of the adjusted initial beam 33d. Alternatively, for example, the emitter slow axis lens 52 can be designed to focus the emitter beam 22 as a point on the beam intersection area 31 in the slow axis. As a non-exclusive example, the emitter slow axis lens can be a cylindrical plano-convex lens with focal length of approximately eleven millimeters.

In this design, (i) the initial beam 33 has different diverging angles when it exits the emitter 40, and (ii) the emitter beam 22 exiting the emitter assembly 30 is converging along the fast axis (at the beam intersection area 31) because of the emitter fast axis lens 48 and collimated along the slow axis because of the emitter slow axis lens 52. By combining the converging beam along the fast axis with the parallel beam along the slow axis, the emitter beam 22 will have a line-like shape at the beam intersection area 31.

It should be noted that other designs of the emitter fast axis lens 48 and/or the emitter slow axis lens 52 are possible. For example, the emitter fast axis lens 48 and/or the emitter slow axis lens 52 can be replaced by a separate lens that performs both functions.

The emitter fast axis lens 48, the beam shifter 50, and the emitter slow axis lens 52 can be made of any material that is operable for the wavenumbers of the emitter beams 22.

It should be noted that because of the different rates of diversion of the initial beam 33, the emitter fast axis lens 48 can be designed and tailored to match the diversion rate along the fast axis 33a, and the emitter slow axis lens 52 can be designed and tailored to match the diversion rate along the slow axis 33b.

FIG. 1C is a cut-away of the emitter assembly 30 taken on line 1C-1C in FIG. 1B. FIG. 1C illustrates the emitter carrier 42, the emitter mount 44, and the connector pin 46a.

FIG. 1D is a simplified, side view of the emitter assembly 30 of FIG. 1B. FIG. 1D illustrates the emitter carrier 42, the emitter mount 44, the connector pin 46a, the emitter 40, the emitter fast axis lens 48, the beam shifter 50, and the emitter slow axis lens 52.

FIG. 1E is a simplified, top view of the emitter assembly 30 of FIG. 1B. FIG. 1E illustrates the emitter carrier 42, the emitter mount 44, the connector pin 46a, the emitter 40, the emitter fast axis lens 48, the beam shifter 50, and the emitter slow axis lens 52.

FIG. 1F is a top schematic that illustrates the path of the fourth emitter beam 22d, and the fifth emitter beam 22e relative to the fast axis. More specifically, FIG. 1F illustrates (i) a fourth emitter 40d and its corresponding, fourth emitter fast axis lens 48d for the fourth emitter assembly 30d; (ii) a fifth emitter 40e and its corresponding, fifth emitter fast axis lens 48e for the fifth emitter assembly 30e; (iii) the first combiner lens 34; (iv) the third combiner lens 38; and (v) the optical fiber 16. It should be noted that the corresponding emitter slow axis lens 52 (see FIG. 1B), and the second combiner lens 36 (see FIG. 1A) are not shown in FIG. 1F because these elements do not act on the emitter beams 22d, 22e in the fast axis.

In this example, the fourth emitter 40d generates the initial beam 33 that is rapidly diverging in the fast axis, and the fourth emitter fast axis lens 48d receives the initial beam 33, and converges and focuses initial beam 33 along the fast axis so that the fourth emitter beam 22d is converging and focused at the beam intersection area 31. It should be noted that the fourth emitter beam 22d is slightly defocused when it is incident on the first combiner lens 34.

Similarly, in this example, the fifth emitter 40e generates the initial beam 33 that is rapidly diverging in the fast axis, and the fifth emitter fast axis lens 48e receives the initial beam 33, and converges and focuses initial beam 33 along the fast axis so that the fifth emitter beam 22e is converging and focused at the beam intersection area 31. It should be noted that the fifth emitter beam 22e is slightly defocused when it is incident on the first combiner lens 34.

Further, FIG. 1F illustrates that for the fast axis, after going through the first combiner lens 34, the emitter beams 22d, 22e are now traveling along substantially parallel paths along the output axis 14A. This can be referred to as a parallel beam set.

Next, the parallel beam set passes through the second combiner lens 36 (not shown in FIG. 1F) without change along the fast axis, and is incident on the third combiner lens 38 that condenses the parallel beam set along the fast axis to focus the assembly output beam 14 along the fast axis on the fast axis and slow axis, rear side focal point 24b.

FIG. 1F also illustrates that the emitter assemblies 30d, 30e are designed and positioned so that the emitter beams 22e, 22d are directed at and intersect on the beam intersection area 31. In this example, each emitter fast axis lens 48d, 48e has a front focal length (“ff”), and a rear focal length (“Lf”). In FIG. 1F, the fourth emitter fast axis lens 48d is positioned so that its front focal length “ff” is approximately at the outlet facet of the fourth emitter 40e; and the fifth emitter fast axis lens 48e is positioned so that its front focal length “ff” is approximately at the outlet facet of the fifth emitter 40e. Further, the fourth emitter fast axis lens 48d is positioned so that its rear focal length “Lf” is at the beam intersection area 31; and the fifth emitter fast axis lens 48e is positioned so that its rear focal length “Lf” is at the beam intersection area 31.

Moreover, the first combiner lens 34 is positioned so that its front focal length (“FL”) is at the beam intersection area 31.

Additionally, the third combiner lens 38 has a rear focal length (“Ffo”) and the third combiner lens 38 is positioned at so that its rear focal length is at the desired fast axis and slow axis, rear side focal point 24b.

£ Further, the optical fiber 16 is positioned so that its inlet facet 16A is approximately positioned at the fast axis and slow axis, rear side focal point 24b.

FIG. 1G is a simplified, side schematic that illustrates the path of the fifth emitter beam 22d relative to the slow axis. More specifically, FIG. 1G illustrates (i) the fifth emitter 40e and its corresponding, fifth emitter slow axis lens 52e for the fifth emitter assembly 30e; (ii) the second combiner lens 36; and (iii) the optical fiber 16. It should be noted that the corresponding emitter fast axis lens 48 (illustrated in FIG. 1F), the first combiner lens 34 (illustrated in FIG. 1F), and the third combiner lens 38 (illustrated in FIG. 1A) are not shown in FIG. 1G because these elements do not act on the emitter beam 22d in the slow axis.

In this example, the fifth emitter 40e generates the initial beam 33 that is slowly diverging in the slow axis, and the fifth emitter slow axis lens 48e receives the initial beam 33, and collimates the initial beam 33 along the slow axis directed at the beam intersection area 31 (illustrated in FIG. 1F) and the second combiner lens 36.

Further, FIG. 1G illustrates that for the slow axis, after going through the second combiner lens 36, the emitter beam 22e is focused on the inlet facet 16A of the optical fiber 16. Stated in a different fashion, the second combiner lens 36 condenses the parallel beam set along the slow axis and focuses the parallel beam set along the slow axis onto the fast axis and slow axis, rear side focal point 24b.

FIG. 1G also illustrates that the fifth emitter slow axis lens 52e has a front focal length (“fs”), and the fifth emitter slow axis lens 52e is positioned so that its front focal length is approximately at the outlet facet of the fifth emitter 40e. Further, the second combiner lens 36 has a rear focal length (“Fs”), and the combiner lens 36 is positioned at so that its rear focal length (“Fs”) is at the fast axis and slow axis, rear side focal point 24b. Moreover, the inlet facet 16A of the optical fiber 16 is positioned approximately at the fast axis and slow axis, rear side focal point 24b.

In FIGS. 1F and 1G, Qo represents the acceptance angle of the output fiber 16. As a non-exclusive example, the acceptance angle can be 0.22 rads. However, other values are possible.

The following parameters are also referenced in the FIG. 1F: (i) sigma (“σ”) represents the Gaussian distribution of the laser beam intensity; (ii) alpha (“α”) represents the laser beam fast axis diverging half angle measured at 1/e2 level; (iii) beta f (“βf”) represents the fast axis beam converging half angle after fast axis lens; (iv) “Af” represents the fast axis beam size at the distance of ff; and (v) “Sf” represents the collimated fast axis beam size. As non-exclusive examples, these parameters approximately, can be the following: α=0.26 rad; βf=0.0052 rad; Af=1.45 millimeters; Sf=6.7 millimeters; and Lf=130 millimeters.

Additionally, the following parameters are referenced in the FIG. 1G: (i) alpha s (“αs”) represents the laser beam slow axis diverging half angle measured at 1/e2 level; (ii) “So” represents the slow axis beam size at the position of the second lens of the collimator lens assembly; and (iii) “Ls” represents the distance between the slow axis lens 52e and the second combiner lens 36. As non-exclusive example, these parameters approximately can be the following: αs=0.078 rad; So=3.4 millimeters; and Ls=187 millimeters.

FIG. 1H is a simplified illustration of the plurality of emitter beams 22a-22i converging at the beam intersection area 31. This Figure illustrates that each of the emitter beams 22a-22i has a different angle of incidence relative to an imaginary plane P positioned at the beam intersection area 31. More specifically, (i) the first emitter beam 22a has a first angle of incidence 54a; (ii) the second emitter beam 22b has a second angle of incidence 54b; (iii) the third emitter beam 22c has a third angle of incidence 54c; (iv) the fourth emitter beam 22d has a fourth angle of incidence 54d; (v) the fifth emitter beam 22e has a fifth angle of incidence 54e; (vi) the sixth emitter beam 22f has a sixth angle of incidence 54f; (vii) the seventh emitter beam 22g has a seventh angle of incidence 54g; (viii) the eighth emitter beam 22h has an eighth angle of incidence 54h; and (ix) the ninth emitter beam 22i has a ninth angle of incidence 54i. Further, each angle of incidence 54a-54i is different from the others.

It should be noted that the numerical aperture and core size of the output fiber 16 (illustrated in FIG. 1A) sets the limit on the maximum angle of incidence 54a-54i of the emitter beams 22a-22i. In one example, the range of acceptable angles of the emitter beams 22a-22i on the first level beam intersection area 331a is equal to the acceptance angle (Qo) of the inlet facet of the optical fiber 16.

In one, non-exclusive example, the present design can provide coupling of at least eighteen emitter beams 22 into the output fiber 16 having a core size 105 microns, and a numerical aperture of 0.22. This design is close to the theoretical limit for the spatial beam combining.

With reference to FIGS. 1A-1H, the laser assembly 12 includes the plurality of vertically mounted emitters 40 arranged in an amphitheater arrangement, with each emitter assembly 30 including the emitter fast axis lens 48 that converges the initial beam 33 along the fast axis, and the emitter slow axis lens 52 that collimates the initial beam 33 along the slow axis.

Further, the emitter assemblies 30 are designed and positioned so that the emitter beams 22 converge radially on the beam intersection area 31. After passing through the beam intersection area 31, the common first combiner lens 34 collects the emitter beams 22 and creates a collimated array of co-propagating collimated horizontally stacked beams, which is then focused onto inlet facet 16A of the optical fiber 16 with the second and third combiner lens 34, 36. One key advantage of this approach, is the ability to combine multiple emitter beams 22 without individual turning mirrors.

It should be noted that in the design of FIGS. 1A-1H, the laser assembly 12 is a single layer design, and includes a single emitter array 20 with its emitter assemblies 30 being at approximately the same height along the Z axis.

Alternatively, the laser assembly 12 can be designed to be a multi-layer design with multiple emitter arrays 20 positioned at different Z axis positions. In this design, each laser layer can produce either combined emitter beams that are focused on the input facet of the output fiber, or collimated beams that can be combined with other collimated beams from the additional laser layers.

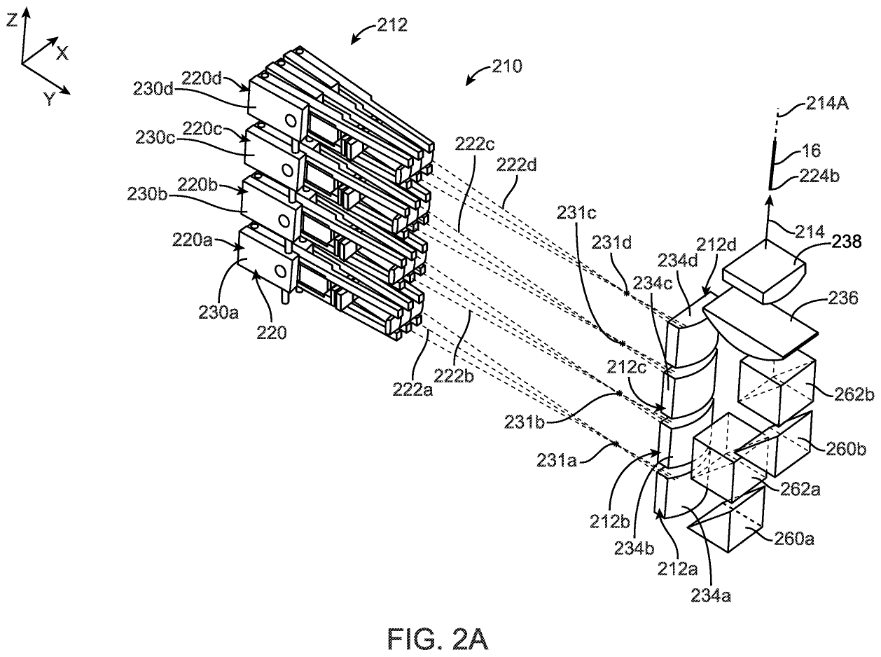

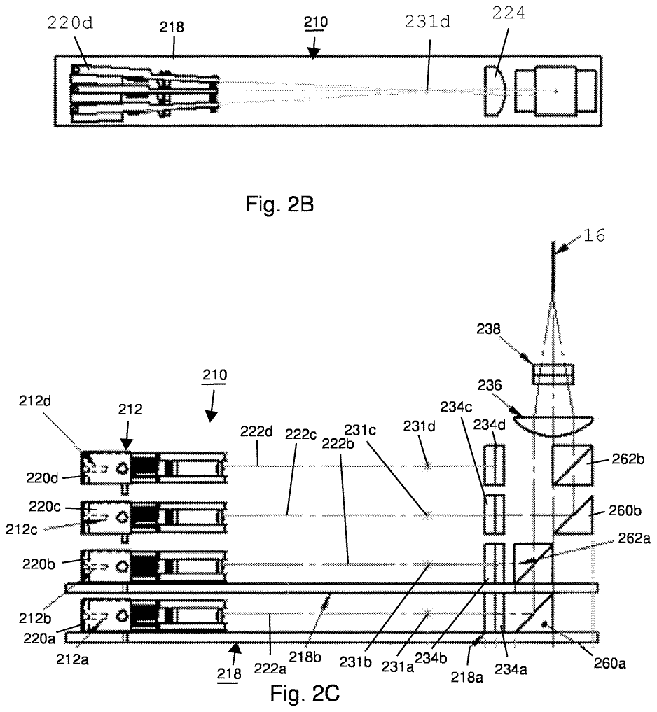

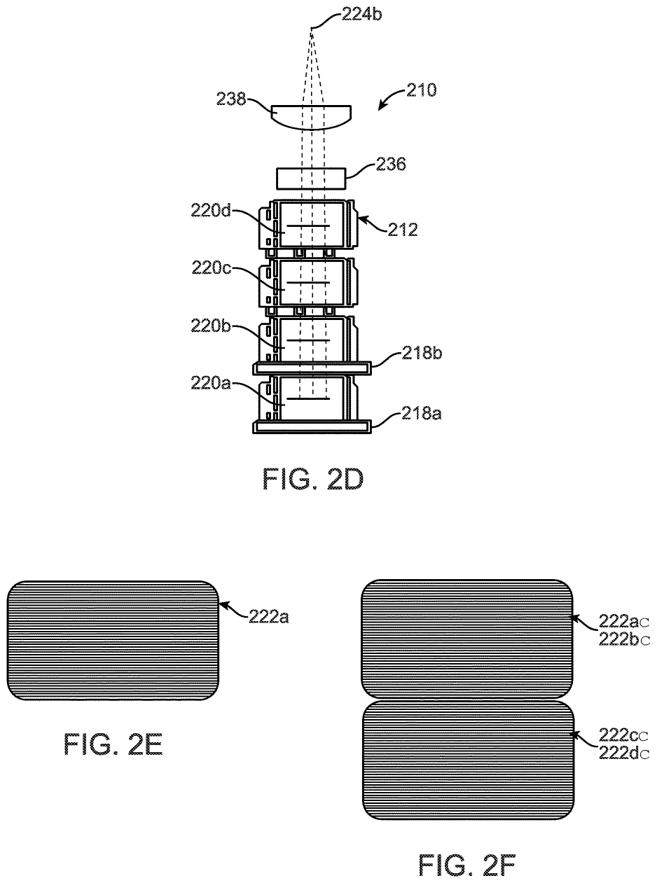

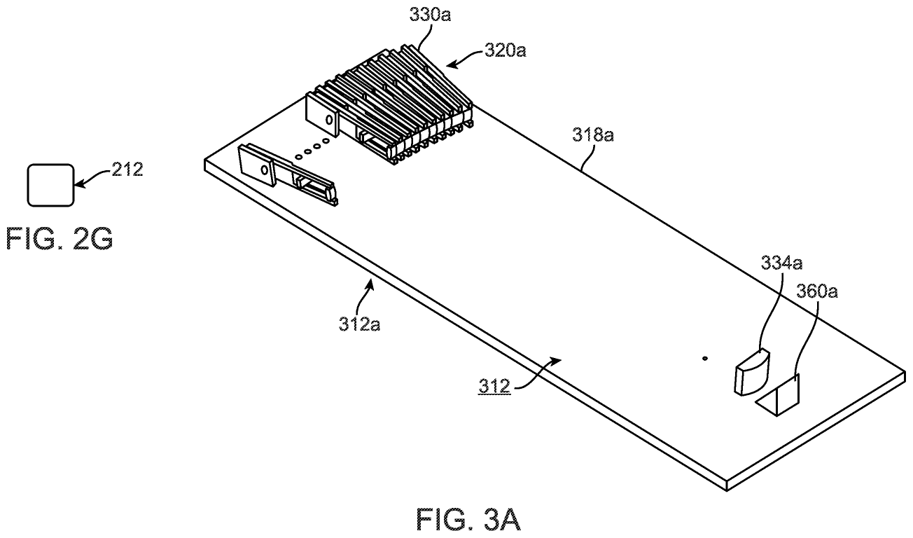

FIG. 2A is a simplified perspective illustration of a system 210 that includes the optical fiber 16, and an alternative design for the laser assembly 212. In this design, the laser assembly 212 is a multi-layer (level) arrangement that includes multiple emitter arrays 220 positioned at different Z axis positions. More specifically, in FIG. 2A, the laser assembly 212 includes four, stacked emitter arrays 220. Alternatively, the laser assembly 212 can be designed to have more than four or fewer than four emitter arrays 220.

It should be noted that the multi-layer arrangement allows for the number of emitter assemblies 230 to be increased, thereby increasing the optical power of the assembly output beam 214. Thus, the design of laser assembly 212 can be easily adjusted to add or remove emitter assemblies 230 based on the desired output power of the assembly output beam 214.

It should be noted that one or more of the emitter assemblies 230 can be similar in design to the emitter assembly 30 described above in reference to FIG. 1B, or any other of the emitter assemblies described below.

In FIG. 2A, moving from the bottom to the top, the laser assembly 212 includes (i) a first laser level 212a that includes a first level emitter array 220a having a plurality of first level emitter assemblies 230a that each generate a separate first level emitter beam 222a, and the first level emitter beams 222a are directed to converge and overlap at a first level beam intersection area 231a; (ii) a second laser level 212b that includes a second level emitter array 220b having a plurality of second level emitter assemblies 230b that each generate a separate second level emitter beam 222b, and the second level emitter beams 222b are directed to converge and overlap at a second level beam intersection area 231b that is spaced apart from the first level beam intersection area 231a; (iii) a third laser level 212c that includes a third level emitter array 220c having a plurality of third level emitter assemblies 230c that each generate a separate third level emitter beam 222c, and the third level emitter beams 222c are directed to converge and overlap at a third level beam intersection area 231c that is spaced apart from the first and second level beam intersection areas 231a, 231b; and (iv) a fourth laser level 212d that includes a fourth level emitter array 220d having a plurality of fourth level emitter assemblies 230d that each generates a fourth level emitter beam 222d, and the fourth level emitter beams 222d are directed to converge and overlap at a fourth level beam intersection area 231d that is spaced apart from the first, second and third level beam intersection areas 231a, 231b, 231c.

It should be noted that the laser frame 18, the power supply 28, and the system controller 26 (illustrated in FIG. 1A) are not shown in FIG. 2A for ease of illustrating the other components.

In the simplified design of FIG. 2A, each level emitter array 220a-220d includes only three spaced apart level emitter assemblies 230a-230d. Alternatively, one or more of the level emitter arrays 220a-220d can be designed to include more than three or fewer than three level emitter assemblies 230a-230d. In alternative, non-exclusive examples, each level emitter arrays 220a-220d can include at least three, four, five, ten, fifteen, or eighteen spaced apart level emitter assemblies 230a-230d.

In FIG. 2A, the combiner lens assembly 224 is designed to spatially combine the level emitter beams 222a-222d into the assembly output beam 214 directed along the output axis 214A. The design of the combiner lens assembly 224 can be varied to suit the number of emitter levels 212a-212d and the rest of the system 210. As an overview, in the non-exclusive implementation of FIG. 2A, the combiner lens assembly 224 includes (i) a first level first combiner lens 234a that combines the first level emitter beams 222a to form a first level combined beam 222ac (illustrated in FIG. 2E); (ii) a first level turn mirror 260a; (iii) a second level first combiner lens 234b that combines the second level emitter beams 222b to form a second level combined beam 222bc (illustrated in FIG. 2F); (iv) a second level beam combiner 262a; (v) a third level first combiner lens 234c that combines the third level emitter beams 222c to form a third level combined beam 222cc (illustrated in FIG. 2F); (vi) a third level turn mirror 260b; (vii) a fourth level first combiner lens 234d that combines the fourth level emitter beams 222d to form a fourth level combined beam 222dc (illustrated in FIG. 2F); (viii) a fourth level beam combiner 262b; (ix) a second combiner lens 236; and (x) a third combiner lens 238.

In FIG. 2A, the first level first combiner lens 234a and the first level turn mirror 260a are part of the first laser level 212a. Similar to the design described in reference to FIG. 1A, the first level first combiner lens 234a (i) is a fast axis collimator lens having a fast axis, front focal point that is positioned at the first level beam intersection area 231a; and (ii) directs the first level emitter beams 222a to be substantially parallel to one another (e.g., parallel to the Y axis) at the first level turn mirror 260a. Further, the first level turn mirror 260a redirects the first level emitter beams 222a ninety degrees (e.g., parallel to the Z axis) at the second level beam combiner 262a.

Somewhat similarly, the second level first combiner lens 234b and the second level beam combiner 262a are part of the second laser level 212b. Similar to the design described in reference to FIG. 1A, the second level first combiner lens 234b (i) is a fast axis collimator lens having a fast axis, front focal point that is positioned at the second level beam intersection area 231b; and (ii) directs the second level emitter beams 222b to be substantially parallel to one another (e.g., parallel to the Y axis) at the second level beam combiner 262a. Further, in this design, the second level beam combiner 262a combines (and optionally overlaps) the first level emitter beams 222a and the second level emitter beams 222a, and directs these emitter beams 222a, 222b at the second combiner lens 236.

The design of the second level beam combiner 262a can be varied in view of the design of the system 210. For example, (i) the first level emitter beams 222a can be in a first wavelength range, (ii) the second level emitter beams 222a can be in a second wavelength range that is different from the first wavelength range, and (iii) the second level beam combiner 262a can be a spectral beam combiner that reflects light in the second wavelength range and transmits light in the first wavelength range. In an alternative example, (i) the first level emitter beams 222a can have a first polarization, (ii) the second level emitter beams 222a can have a second polarization that is different from the first polarization, and (iii) the second level beam combiner 262a can be a polarization beam combiner that reflects light having the second polarization and transmits light having the first polarization.

Further, the third level first combiner lens 234c and the third level turn mirror 260b are part of the third laser level 212c. Similar to the design described in reference to FIG. 1A, the third level first combiner lens 234c (i) is a fast axis collimator lens having a fast axis, front focal point that is positioned at the third level beam intersection area 231c; and (ii) directs the third level emitter beams 222c to be substantially parallel to one another (e.g., parallel to the Y axis) at the third level turn mirror 260b. Further, the third level turn mirror 260b redirects the third level emitter beams 222c ninety degrees (e.g., parallel to the Z axis) at the fourth level beam combiner 262b.

Somewhat similarly, the fourth level first combiner lens 234d and the fourth level beam combiner 262b are part of the fourth laser level 212d. Similar to the design described in reference to FIG. 1A, the fourth level first combiner lens 234d (i) is a fast axis collimator lens having a fast axis, front focal point that is positioned at the fourth level beam intersection area 231d; and (ii) directs the fourth level emitter beams 222d to be substantially parallel to one another (e.g., parallel to the Y axis) at the fourth level beam combiner 262b. Further, in this design, the fourth level beam combiner 262b combines (and optionally overlaps) the third level emitter beams 222c and the fourth level emitter beams 222d and directs these emitter beams 222c, 222d at the second combiner lens 236.

The design of the fourth level beam combiner 262b can be similar to the design of the second level beam combiner 262a. For example, (i) the third level emitter beams 222c can be in a third wavelength range, (ii) the fourth level emitter beams 222d can be in a fourth wavelength range that is different from the third wavelength range, and (iii) the fourth level beam combiner 262b can be a spectral beam combiner that reflects light in the fourth wavelength range and transmits light in the third wavelength range. In an alternative example, (i) the third level emitter beams 222c can have a first polarization, (ii) the fourth level emitter beams 222d can have a second polarization that is different from the first polarization, and (iii) the fourth level beam combiner 262b can be a polarization beam combiner that reflects light having the second polarization and transmits light having the first polarization.

The second combiner lens 236 can be similar to the corresponding second combiner lens 36 described above. For example, the second combiner lens 236 can be a slow axis condenser lens that directs the emitter beams 222a-222d to converge and focus on the fast axis and slow axis, rear side focal point 224b along the slow axis.

Moreover, the third combiner lens 238 can be similar to the corresponding third combiner lens 238 described above. For example, the third combiner lens 238 can be a fast axis condenser lens that directs the emitter beams 222a-222d to converge and focus on the fast axis and slow axis, rear side focal point 224b along the fast axis.

It should be noted that in the design of FIG. 2A, the laser assembly 212 includes a pair of turn mirrors 260a, 260b. However, in this design, the turn mirrors 260a, 260b are relatively large, robust, and easy to maintain properly aligned. Further, the size of the turn mirrors 260a, 260b does not adversely influence the spacing of the emitters.

It should be noted that (i) after the first level first combiner lens 234a, all of the first level emitter beams 222a are collimated; (ii) after the second level first combiner lens 234b, all of the second level emitter beams 222b are collimated; (iii) after the third level first combiner lens 234c, all of the third level emitter beams 222c are collimated; and (iv) after the fourth level first combiner lens 234d, all of the fourth level emitter beams 222d are collimated. Further, these collimated beams 222a-222d can be combined into the assembly output beam 214 and focused onto the optical fiber 16 as illustrated in FIG. 2A.

Alternatively, these collimated beams can be combined into the assembly output beam 214 and launched into free space.

Still alternatively, for example, the emitter beams 222a-222d of each laser level 212a-212d can be individually coupled to a separate optical fiber (not shown). In this design, each laser level 212a-212d can include its own level second combiner lens (not shown) and level third combiner lens (not shown). In yet another alternate implementation, the emitter beams 222a-222d from two or three laser level 212a-212d can be coupled to a separate optical fiber (not shown).

FIG. 2B is a top illustration of the system 210 of FIG. 2A illustrating the fourth level emitter array 220d, the fourth level beam intersection area 231d, and the combiner lens assembly 224. It should be noted that in FIG. 2B, a portion of the laser frame 218 is illustrated.

FIG. 2C is a side illustration of the system 210 of FIG. 2A including the laser assembly 212 and the optical fiber 16. FIG. 2C illustrates that the laser assembly 212 includes (i) the first laser level 212a including the first level emitter array 220a, the first level beam intersection area 231a, the first level first combiner lens 234a, and the first level turn mirror 260a; (ii) the second laser level 212b including the second level emitter array 220b, the second level beam intersection area 231b, the second level first combiner lens 234b, and the second level beam combiner 262a; (iii) the third laser level 212c including the third level emitter array 220c, the third level beam intersection area 231c, the third level first combiner lens 234c, and the second level turn mirror 260b; (iv) the fourth laser level 212d including the fourth level emitter array 220d, the fourth level beam intersection area 231d, the fourth level first combiner lens 234d, and the fourth level beam combiner 262d; (v) the second combiner lens 236; and (vi) the third combiner lens 238.

It should be noted that FIG. 2C also illustrates that the laser frame 218 includes a first level frame 218a that supports and retains the components of the first laser level 212a, and a second level frame 218b that supports and retains the components of the second laser level 212b. Additionally, the laser frame 218 can include a third level frame (not shown) that supports and retains the components of the third laser level 212c, and/or a fourth level frame (not shown) that supports and retains the components of the fourth laser level 212d. For example, each level frame 212a, 212b can be a rigid, rectangular shaped plate. Alternatively, other designs of the level frames 212a, 212b are possible. It should be noted that the second, third, and fourth level frames 212b can include openings in the appropriate locations to allow for the emitter beams 222a-222d to be combined.

In this design, for example, each laser level 212a-212d can be individual assembled and aligned. Next, the laser levels 212a-212d can be assembled and aligned with the second combiner lens 236 and the third combiner lens 238.

In one example, the temperature of one or more (e.g., all) level frames 218a, 218b can be individually controlled. Further, one or more (e.g., all) level frames 218a, 218b can function as a heat sink.

FIG. 2D is an end illustration of the system 210 of FIG. 2A including the laser assembly 212 with the emitter arrays 220a, 220b, 220c, 220d, the level frames 218a, 218b, the second combiner lens 236, and the third combiner lens 238. FIG. 2D also illustrates that the beams are focused at the fast axis and slow axis, rear side focal point 224b.

FIG. 2E is a simplified illustration of the profile of the first level combined beams 222ac at the output of the first level, first combiner lens 234a (illustrated in FIG. 2A).

FIG. 2F is a simplified illustration of (i) the profile of the first level combined beams 222ac and the second level combined beams 222bc after they are spatially combined, and (ii) the profile of the third level combined beams 222cc and fourth level combined beams 222dc after they are spatially combined at the output of the second combiner lens 238 (illustrated in FIG. 2A).

FIG. 2G illustrates the profile of the assembly output beam 212 at the inlet facet of the optical fiber 16 (illustrated in FIG. 2A) after the combined beams 222ac, 222bc, 222cc, 222dc have been focused by the second combiner lens 236.

In one specific example, the four level laser assembly can be assembled having a total number of eighteen emitter assemblies per layer, with an optical fiber having a fiber core diameter H=0.105 millimeters, fiber acceptance angle Qo=0.22 rad. Further, each emitter can have (i) fast angle parameters measured at 1/e2: wf=0.002 mm, αf=15 degree=0.0785 rad; and (ii) laser slow angle parameters measured at FWHM (flat top beam): ws=0.1 millimeters, αs=4.5 degree=0.26 rad.

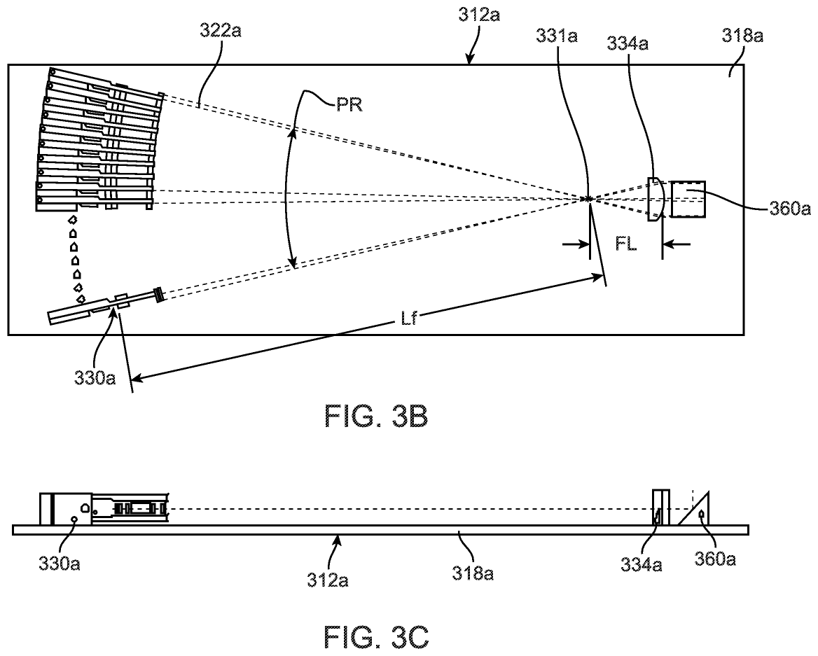

FIG. 3A is a simplified perspective illustration of a portion of another implementation of the laser assembly 312. In this example, only the first laser level 312a including the first level frame 318a, the first level emitter array 320a, the first level first combiner lens 334a, and the first level turn mirror 360a are shown. In this design, the first level emitter array 320a is designed to include eighteen, spaced apart, first level emitter assemblies 330a (although only eleven are shown). It should be noted that one or more (e.g., all) of the emitter assemblies 330a can be similar in design to the emitter assembly 30 described above in reference to FIG. 1B, or any other of the emitter assemblies described below.

Additionally, it should be noted that the arrangement of emitter assemblies 330a can be used in any of the layers of FIG. 2A, or in the laser assembly 12 of FIG. 1A.

FIG. 3B is a top illustration of the first laser level 312a of FIG. 3A, including the first level frame 318a, the first level emitter assemblies 330a, the first level beam intersection area 331a, the first level combiner lens 334a, and the first level turn mirror 360a. In this design, (i) the first level emitter assemblies 330a are positioned so that the rear focal length “Lf” is at the first level beam intersection area 331a; and (ii) the first level combiner lens 334a is positioned so that it front side focal length “FL” is also at the first level beam intersection area 331a.

Also, in FIG. 3B, PR represents the range of acceptable angles of the first level emitter beams 322a on the first level beam intersection area 331a. In certain designs, the range of acceptable angles is equal to the acceptance angle (Qo) of the inlet facet of the optical fiber 16 (illustrated in FIG. 1A).

FIG. 3C is a side illustration of the first laser level 312a including the first level frame 318a, the first level emitter assemblies 330a, the first level combiner lens 334a, and the first level turn mirror 360a.

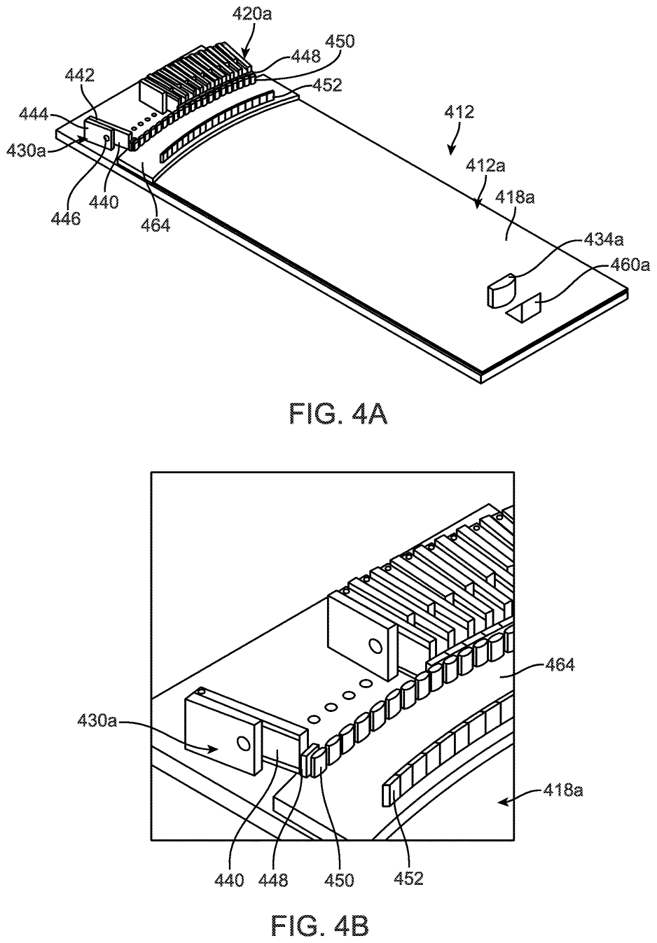

FIG. 4A is a simplified perspective illustration of a portion of yet another implementation of the laser assembly 412. In FIG. 4A, only the first laser level 412a including the first level frame 418a, the first level emitter array 420a, the first level combiner lens 434a, and the first level turn mirror 460a are shown. In this design, the first level frame 418a, the first level combiner lens 434a, and the first level turn mirror 460a are somewhat similar to the corresponding components described above and illustrated in FIG. 3A. However, in FIG. 4A, the first level emitter array 420a is different from the design in FIG. 3A.

More specifically, in FIG. 4A, the first level emitter array 420a is again designed to include eighteen, spaced apart, first level emitter assemblies 430a (although only eleven are shown). However, in FIG. 4A, the design of the first level emitter assemblies 430a is slightly different. For example, in FIG. 4A, each first level emitter assembly 430a includes (i) an emitter 440; (ii) an emitter carrier 442; (iii) an emitter mount 444; (iv) a connector assembly 446; (v) an emitter fast axis lens 448; (vi) an emitter beam shifter 450; and (vii) an emitter slow axis lens 452 that are similar to the corresponding components described above in reference to FIG. 1B. However, in FIG. 4A, the emitter carrier 442 does not include the carrier arms 42b, 42c (illustrated in FIG. 1B), and the first level frame 418a additionally includes a mount frame 464 that retains the emitter fast axis lens 448, the emitter beam shifter 450, and the emitter slow axis lens 452 for each first level emitter assemblies 430a. In this non-exclusive design, (i) the plurality of micro, emitter fast axis lens 448 can be spaced apart, arranged in an arch shaped configuration, and fixedly secured to the mount frame 464; (ii) the plurality of micro, emitter beam shifters 450 can be spaced apart, arranged in an arch shaped configuration, and fixedly secured to the mount frame 464; and (iii) the plurality of micro, emitter slow axis lens 452 can be spaced apart, arranged in an arch shaped configuration, and fixedly secured to the mount frame 464. However, other arrangements are possible.

In the design of FIG. 4A, the plurality of emitter fast axis lens 448, emitter beam shifter 450, and emitter slow axis lens 452 can be accurately mounted to the first laser frame 418a, and subsequently each of the first level laser assemblies 430a can be accurately attached to the first laser frame 418a.

FIG. 4B is an enlarged view of a portion of FIG. 4A including a portion of the first level frame 418a, the first level emitter assemblies 430a and emitters 440, and the mount frame 464 retaining the plurality of emitter fast axis lens 448, emitter beam shifter 450, and emitter slow axis lens 452.

It should be noted that the design of the first level emitter assemblies 430a illustrated in FIGS. 4A and 4B can be used in any of the laser layers in the design of FIGS. 2A-2D, or in the laser assembly 12 of FIG. 1A.

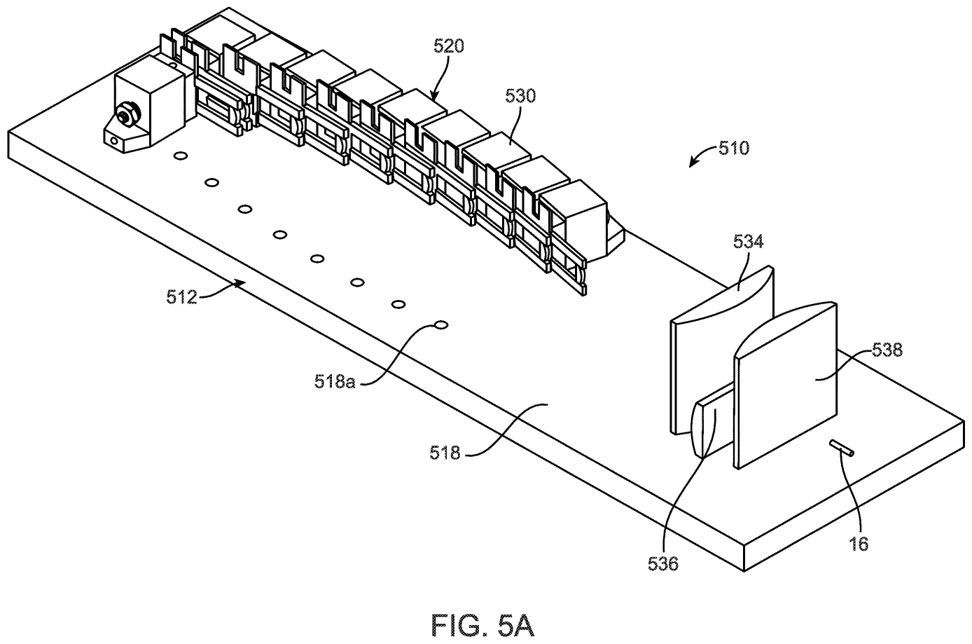

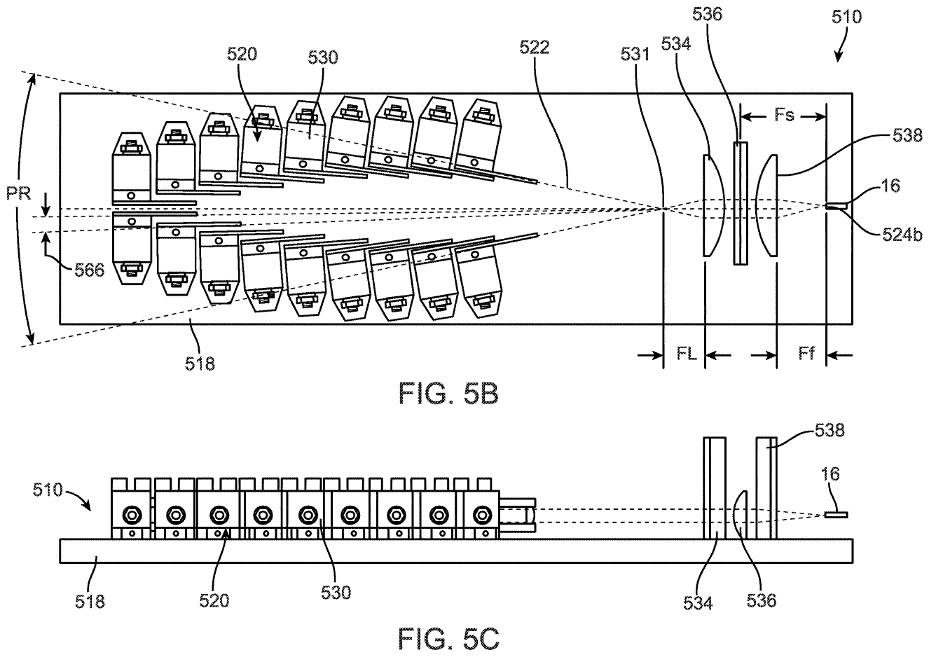

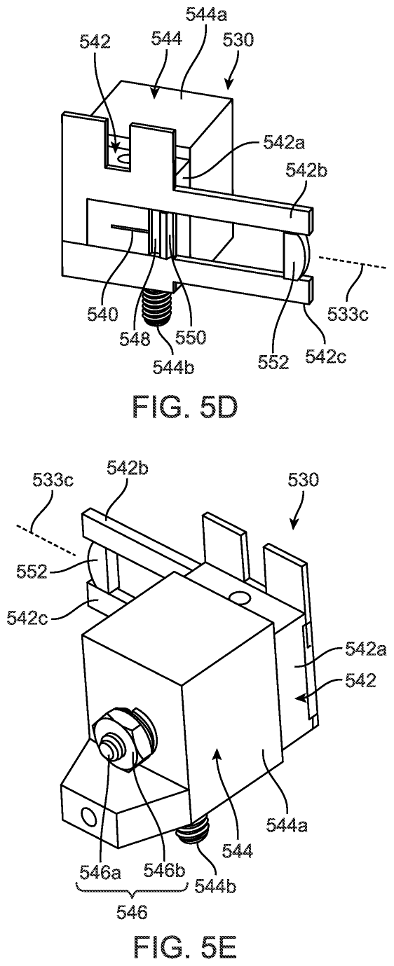

FIG. 5A is a simplified perspective illustration of a yet another implementation of a system 510 that includes an optical fiber 16, and a laser assembly 512. In this example, the laser assembly 512 includes (i) a laser frame 518; (ii) an emitter array 520 having a plurality of emitter assemblies 530; (iii) a first combiner lens 534, (iv) a second combiner lens 536; and (v) a third combiner lens 538 that are somewhat similar to the corresponding components described above and illustrated in FIG. 1A. In the design of FIG. 5A, the emitter array 520 is designed to include eighteen, spaced apart, emitter assemblies 530 (although only ten are shown). However, the arrangement and design of each of the emitter assemblies 530 is slightly different than that illustrated in FIG. 1A. More specifically, in FIG. 5A, the emitter assemblies 530 are arranged and positioned in a “V” shaped configuration. It should be noted that design and/or arrangement of the emitter assemblies 530 illustrated in FIG. 5A can be used in the other designs disclosed herein. Further, the configuration of FIG. 5A can be modified to be a multiple level arrangement.

FIG. 5B is a top illustration of the system 510 of FIG. 5A including the optical fiber 16, the laser frame 518, the emitter array 520 with the plurality of emitter assembly 530, the first combiner lens 534, the second combiner lens 536, and the third combiner lens 538. Similar to the designs above, each emitter assembly 530 emits a separate emitter beam 522, and the emitter assemblies 530 are positioned so that the plurality of emitter beams 522 are directed radially at and intersect at the beam intersection area 531.

In this design, the emitter assemblies 530 are positioned so that the angle of incidence of the emitter beams 522 relative to the beam intersection axis 531 is different for each emitter assembly 530. Further, in FIG. 5B, PR represents the range of acceptable angles of the emitter beams 522 on the beam intersection area 531. In certain designs, the range of acceptable angles is equal to the acceptance angle (Qo) of the inlet facet of the optical fiber 16.

FIG. 5B also illustrates that (i) the first combiner lens 534 is positioned so that its front focal length FL is positioned on the beam intersection area 531, (ii) the second combiner lens 536 is positioned so that its rear focal length Fs is positioned at the desired fast axis and slow axis, rear side focal point 524b, (iii) the third combiner lens 538 is positioned so that its rear focal length Ff is positioned at the desired fast axis and slow axis, rear side focal point 524b, and (iv) the optical fiber 16 is positioned approximately at the fast axis and slow axis, rear side focal point 524b.

In FIG. 5B, the difference in angle of incidence 566 between two adjacent emitter beams 522 is also referenced. Generally speaking, as the number of emitter assemblies 530 is increased, the value of the angle of incidence 566 is decreased.

FIG. 5C is a side illustration of the system 510 of FIG. 5A including the optical fiber 16, the laser frame 518, the emitter array 520 with the plurality of emitter assemblies 530, the first combiner lens 534, the second combiner lens 536, and the third combiner lens 538.

FIG. 5D is a first perspective view and FIG. 5E is an alternative perspective view of one of the emitter assemblies 530 from FIGS. 5A-5C. In this design, each emitter assembly 530 includes (i) an emitter 540; (ii) an emitter carrier 542; (iii) an emitter mount 544; (iv) a connector assembly 546; (v) an emitter fast axis lens 548; (vi) an emitter beam shifter 550; and (vii) an emitter slow axis lens 552 that are somewhat similar to the corresponding components described above in reference to FIG. 1B. In FIG. 5D, the design and positioning of these components can be varied to achieve the design requirements of the emitter assembly 530.

The emitter carrier 542 retains the emitter 540, the emitter fast axis lens 548, the emitter beam shifter 550, and the emitter slow axis collimating lens 552 in a spaced apart configuration along the beam central axis 533c. In the non-exclusive implementation of FIGS. 5D and 5E, the emitter carrier 542 is rigid, and includes (i) a generally rectangular shaped carrier body 542a; (ii) a generally rectangular shaped, first carrier arm 542b that cantilevers away from the carrier body 542a; and (iii) a generally rectangular shaped, second carrier arm 542c that cantilevers away from the carrier body 542a and that is spaced apart from the first carrier arm 542b. In this non-exclusive design, (i) the emitter 540 is attached to the carrier body 542a; and (ii) the emitter fast axis lens 548, the beam shifter 550, and the emitter slow axis lens 552 are attached in a spaced apart configuration to the carrier arms 542b, 542c. In one embodiment, the emitter carrier 542 is made of rigid material and has a relatively high thermal conductivity similar to the design described above. Further, the relatively thin carrier arms 542b, 542c minimize the amount of heat that is transferred to fast axis collimating lens 548, the emitter beam shifter 550, and the slow axis collimating lens 552.

The emitter mount 544 secures the emitter carrier 542 to the laser frame 518 (illustrated in FIG. 5A). In one non-exclusive implementation, the emitter mount 544 is rigid, and includes (i) a generally rectangular shaped mount body 544a; and (ii) a cylindrical shaped, mount rod 544b that cantilevers downward from the mount body 544a. With this non-exclusive design, the mount rod 544b can be positioned within a corresponding frame aperture 518a (illustrated in FIG. 5A) in the laser frame 518. Further, with this design, the emitter assembly 530 can be pivoted (rotated) about an axis that is parallel to its slow axis relative to the laser frame 518 to adjust the pointing of the emitter beam 522 (illustrated in FIG. 5B) until it precisely converges upon and is directed at the beam intersection area 531 (illustrated in FIG. 5B). After the emitter beam 522 is properly pointed, the mount rod 544b can be fixedly secured to the laser frame 18, e.g., using an adhesive, solder, threads, or another type of fastener (e.g., a set screw). The emitter mount 544 can be made to have similar characteristics as the emitter carrier 542.

In certain embodiments, the material used for the emitter mount 544 can be selected so that its coefficient of thermal expansion matches the coefficient of thermal expansion of the emitter 540 and the emitter carrier 542. In certain designs, the emitter mount 544 and/or the emitter carrier 542 are thermally coupled to the laser frame 518 so that heat easily transfers from the emitter 540 to the emitter carrier 542 and the emitter mount 544, and subsequently to the laser frame 518.

The connector assembly 546 connects the carrier body 542 to the emitter mount 544 while allowing for adjustment of the position of the carrier body 542 and the emitter 540 relative to the emitter mount 544. In one non-exclusive implementation, the connector assembly 546 includes a threaded connector pin 546a that is positioned in the carrier body 542 and the emitter mount 544, and a threaded connector fastener 546b. With this design, the carrier body 542 and the emitter 540 can be pivoted (rotated) about the fast axis of the emitter beam 522 relative to the emitter mount 544 and the laser frame 518 to adjust the pointing of the emitter beam 522 until it precisely converges upon and is directed at the beam intersection area 531. After the emitter beam 522 is properly pointed, the threaded connector fastener 546b can be tightened to fixedly secure the emitter mount 544 and the emitter carrier 542.

With the present design, the mount rod 544b and the connector pin 546a allow for the easy alignment of the emitter beam 522 about two axes of rotation.

The emitter fast axis lens 548 is spaced apart from the emitter 540, receives the initial beam 33 (illustrated FIG. 1B), and converges and focuses the initial beam 33 along the fast axis 33a (illustrated in FIG. 1B). As a result thereof, with reference to FIGS. 1B and 5B, the emitter beams 522 are converging along the fast axis 33a at the beam intersection area 531 after the emitter fast axis lens 548. In one example, the emitter fast axis lens 548 is designed and positioned so that the emitter beam 522 is focused on a common point at the beam intersection area 531.

In the implementation of FIG. 5B, the emitter array 520 includes eighteen, separate emitter assemblies 530, including a top set of nine emitter assemblies 530, and a bottom set of nine emitters 530. In this design, (i) each of the emitter assemblies 530 in the top set are at a different distance from the beam intersection area 531, and (ii) each of the emitter assemblies 530 in the bottom set are at a different distance from the beam intersection area 531. In this design, (i) the fast axis lens 548 (illustrated in FIG. 5D) of each of the emitter assemblies 530 in the top set is slightly different so that its respective emitter beam 522 is focused at the beam intersection area 531; and (i) the fast axis lens 548 of each of the emitter assemblies 530 in the bottom set is slightly different so that its respective emitter beam 522 is focused at the beam intersection area 531. In summary, because the emitter assemblies 530 are arranged in a “V” shaped configuration, the design of each emitter fast axis lens 548 must be selected to focus the respective emitter beam 522 along the fast axis at the beam intersection area 531.

While the particular designs as shown and disclosed herein is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A laser assembly that generates an assembly output beam, the laser assembly comprising:
a first emitter assembly that generates a first emitter beam that is directed along a first emitter axis at a first beam intersection area;
a second emitter assembly that generates a second emitter beam that is directed along a second emitter axis at the first beam intersection area; wherein the first emitter beam and the second emitter beam intersect at the first beam intersection area; and
a first combiner lens that receives and spatially combines the first emitter beam and the second emitter beam after the first emitter beam and the second emitter beam have passed through the first beam intersection area.

2. The laser assembly of claim 1 wherein the emitter assemblies are spaced apart and radially positioned relative to the first beam intersection area.

3. The laser assembly of claim 1 wherein the emitter axes are radially positioned relative to the first beam intersection area.

4. The laser assembly of claim 1 wherein each emitter assembly has a fast axis, and wherein the first combiner lens is a fast axis collimating lens that causes the emitter beams to travel substantially parallel as a parallel beam set.

5. The laser assembly of claim 4 further comprising a second combiner lens that condenses the parallel beam set along a slow axis that is orthogonal to the fast axis and focuses the parallel beam set along the slow axis onto a rear side focal area.

6. The laser assembly of claim 5 further comprising a third combiner lens that condenses the parallel beam set along the fast axis to focus the assembly beam along the fast axis on the rear side focal area.

7. A system including the laser assembly of claim 6, and an optical fiber having an inlet facet positioned approximately at the rear side focal area.

8. The laser assembly of claim 1 further comprising a third emitter assembly that generates a third emitter beam that is directed along a third emitter axis at the first beam intersection area; wherein the emitter beams converge at the first beam intersection area; wherein the emitter axes are radially positioned relative to the first beam intersection area.

9. The laser assembly of claim 8 further comprising a fourth emitter assembly that generates a fourth emitter beam that is directed along a fourth emitter axis at the first beam intersection area.

10. The laser assembly of claim 1 wherein the first emitter assembly includes (i) an emitter that generates an initial beam having a fast axis and a slow axis; (ii) a fast axis lens that converges and focuses the initial beam along the fast axis at the first beam intersection area; and (iii) and a slow axis lens that is spaced apart from the fast axis collimating lens, wherein the slow axis lens collimates the initial beam along the slow axis.

11. The laser assembly of claim 1 wherein the first emitter beam has a first center wavenumber, and the second emitter beam has a second center wavenumber that is approximately the same as the first center wavenumber.

12. The laser assembly of claim 1 wherein the first emitter beam has a first center wavenumber and the second emitter beam has a second center wavenumber that is different from the first center wavenumber.

13. The laser assembly of claim 1 wherein the first combiner lens has a fast axis, front side focal point, and wherein the first combiner lens is positioned so that the fast axis, front side focal point is positioned approximately at the first beam intersection area.

14. The laser assembly of claim 1 further comprising (i) a third emitter assembly that generates a third emitter beam that is directed along a third emitter axis at a second beam intersection area that is spaced apart from the first beam intersection area; (ii) a fourth emitter assembly that generates a fourth emitter beam that is directed along a fourth emitter axis at the second beam intersection area; wherein the third emitter beam and the fourth emitter beam intersect at the second beam intersection area; and (iii) a second combiner lens that receives and spatially combines the third emitter beam and the fourth emitter beam after the third emitter beam and the fourth emitter beam have passed through the second beam intersection area.

15. A laser assembly that generates an assembly output beam, the laser assembly comprising:
a first emitter array that generates a plurality of first level emitter beams that are directed to converge upon and intersect at a first beam intersection area; wherein each of the first level emitter beams has a different angle of incidence relative to an imaginary plane positioned at the first beam intersection area; and
a combiner lens assembly that receives and spatially combines the first emitter beams after the first emitter beams have passed through the first beam intersection area.

16. The laser assembly of claim 15 wherein the first level emitter beams are radially positioned relative to the first beam intersection area.

17. The laser assembly of claim 15 wherein each first level emitter beam has a fast axis, and wherein the combiner lens assembly includes a fast axis collimating lens that causes the first level emitter beams to travel substantially parallel as a parallel beam set.

18. The laser assembly of claim 17 wherein the combiner lens assembly includes a slow axis condensing lens that condenses the parallel beam set along a slow axis that is orthogonal to the fast axis and focuses the parallel beam set along the slow axis onto a rear side focal area.

19. The laser assembly of claim 18 wherein the combiner lens assembly includes a fast axis condensing lens that condenses the parallel beam set along the fast axis to focus the assembly beam along the fast axis onto the rear side focal area.

20. A system including the laser assembly of claim 19, and an optical fiber having an inlet facet positioned approximately at the rear side focal area.

21. The laser assembly of claim 15 wherein the combiner lens assembly has a front side focal point and wherein the combiner lens assembly is positioned so that the front side focal point is positioned at the first beam intersection area.

22. The laser assembly of claim 15 further comprising: a second emitter array that generates a plurality of second level emitter beams that are directed to converge upon and intersect at a second beam intersection area that is spaced apart from the first beam intersection area; wherein each of the second level emitter beams has a different angle of incidence relative to an imaginary plane positioned at the second beam intersection area; and wherein the combiner lens assembly receives and spatially combines the second level emitter beams after the second emitter beams have passed through the second beam intersection area.

23. The laser of claim 15 wherein the first emitter array includes a first emitter assembly that generates a first emitter beam that is directed along a first emitter axis at the first beam intersection area; and a second emitter assembly that generates a second emitter beam that is directed along a second emitter axis at the first beam intersection area; wherein the first emitter beam and the second emitter beam intersect at the first beam intersection area; wherein the first emitter assembly includes (i) an emitter that generates an initial beam having a fast axis and a slow axis; (ii) a fast axis lens that converges and focuses the initial beam along the fast axis at the first beam intersection area; and (iii) and a slow axis lens that is spaced apart from the fast axis collimating lens, wherein the slow axis lens collimates the initial beam along the slow axis.

24. A laser assembly that generates an assembly output beam, the laser assembly comprising:
a first level emitter array that generates a plurality of first level emitter beams that are directed to converge upon and intersect at a first level beam intersection area;
a second level emitter array that generates a plurality of second level emitter beams that are directed to converge upon and intersect at a second level beam intersection area; and
a combiner lens assembly that (i) receives and spatially combines the first emitter beams after the first emitter beams have passed through the first beam intersection area; and (ii) receives and spatially combines the second emitter beams after the second emitter beams have passed through the second beam intersection area.

25. The laser assembly of claim 24 wherein the combiner lens assembly spatially combines the first emitter beams and the second emitter beams.

26. The laser of claim 24 wherein the first level emitter array includes a first emitter assembly that generates a first emitter beam that is directed along a first emitter axis at the first beam intersection area; and a second emitter assembly that generates a second emitter beam that is directed along a second emitter axis at the first beam intersection area; wherein the first emitter beam and the second emitter beam intersect at the first beam intersection area; wherein the first emitter assembly includes (i) an emitter that generates an initial beam having a fast axis and a slow axis; (ii) a fast axis lens that converges and focuses the initial beam along the fast axis at the first beam intersection area; and (iii) and a slow axis lens that is spaced apart from the fast axis collimating lens, wherein the slow axis lens collimates the initial beam along the slow axis.

27. A laser assembly that generates an output beam, the laser assembly comprising:
a first emitter assembly that generates a first emitter beam that is directed along a first emitter axis at a first beam intersection area; wherein the first emitter assembly includes (i) an emitter that generates an initial beam having a fast axis and a slow axis; (ii) a fast axis lens that converges and focuses the initial beam along the fast axis at the first beam intersection area; and (iii) and a slow axis lens that is spaced apart from the fast axis collimating lens, wherein the slow axis lens collimates the initial beam along the slow axis;
a second emitter assembly that generates a second emitter beam that is directed along a second emitter axis at the first beam intersection area; wherein the first emitter beam and the second emitter beam intersect at the first beam intersection area; and
a first combiner lens that receives and spatially combines the first emitter beam and the second emitter beam after the first emitter beam and the second emitter beam have passed through the first beam intersection area; wherein the emitter assemblies are spaced apart and radially positioned relative to the first beam intersection area.

28. (canceled)

29. The laser assembly of claim 27 wherein each emitter assembly has a fast axis, and wherein the first combiner lens is a fast axis collimating lens that causes the emitter beams to travel substantially parallel as a parallel beam set.

30. The laser assembly of claim 29 further comprising a second combiner lens that condenses the parallel beam set along a slow axis that is orthogonal to the fast axis and focuses the parallel beam set along the slow axis onto a rear side focal area.

31. The laser assembly of claim 30 further comprising a third combiner lens that condenses the parallel beam set along the fast axis to focus the assembly beam along the fast axis on the rear side focal area.

32. A method for providing an assembly output beam comprising:
directing a first emitter beam along a first emitter axis at a beam intersection area;
directing a second emitter beam along a second emitter axis at the beam intersection area; wherein the first emitter beam and the second emitter beam intersect at the beam intersection area; and
spatially combining the first emitter beam and the second emitter beam with a first combiner lens after the first emitter beam and the second emitter beam have passed through the beam intersection area.

33. A method for providing an assembly output beam comprising:
directing a plurality of first emitter beams to converge upon and intersect at a first beam intersection area; wherein each of the first emitter beams has a different angle of incidence relative to an imaginary plane positioned at the first beam intersection area; and
spatially combining the first emitter beams after the first emitter beams have passed through the first beam intersection area with a combiner lens assembly.

34. A method for providing an assembly output beam comprising:
generating a plurality of first level emitter beams that are directed to converge upon and intersect at a first level beam intersection area;
generating a plurality of second level emitter beams that are directed to converge upon and intersect at a second level beam intersection area that is spaced apart from the first level beam intersection area;
spatially combining the first emitter beams after the first emitter beams have passed through the first beam intersection area to form a first level combined beam; and
spatially combining the second emitter beams after the second emitter beams have passed through the second beam intersection area to form a second level combined beam.

35. The method of claim 34 further comprising spatially combining the first level combined beam and the second level combined beam.
